(19) United States
(12) Patent Application Publication
(10) Pub. No.: US 2026/0260133 A1
(43) Pub. Date: Sep. 3, 2026

(54) EXTENDED PROMPT GENERATION BASED ON A LANGUAGE MODEL AND BUSINESS KNOWLEDGE

(71) Applicant: International Business Machines Corporation, Armonk, NY (US)

(72) Inventors: Yuan Yuan Ding, Shanghai (CN); Kun Yan Yin, Ningbo (CN); Jing Zhang, Shanghai (CN); Shi Yun Liang, Shanghai (CN)

(21) Appl. No.: 19/067,292

(22) Filed: Feb. 28, 2025

(51) Int. Cl. G06N 5/022

(52) U.S. Cl. CPC G06N 5/022

(57) ABSTRACT

Generation of an extended prompt associated with a user prompt includes receiving the user prompt comprising a natural language query. The user prompt is received from a user device. A first set of keywords is determined based on the user prompt and a knowledge base. The first set of keywords includes at least one of a set of domain-specific terms, a set of business logic rules, and context-specific information associated with the user prompt. The knowledge base includes at least one of historical user prompts or one or more business rules. The language model is applied to the user prompt and the first set of keywords. The extended prompt based on the application of the language model is generated., the generated extended prompt is outputted.

### BACKGROUND

The disclosure relates to the generation of a prompt and more particularly, to the generation of an extended prompt.

In the current era of informatization, data has emerged as the nucleus of enterprise operations and decision-making. The rapid development and application of big data technologies have transformed how organizations collect, analyze, and utilize information. As businesses strive to harness the power of data for strategic insights, the demand for efficient and intelligent data analysis and querying has surged.

However, traditional methods of converting natural language text into queries often rely heavily on predefined rules and templates. This approach may be limiting, as it may not accommodate the diverse ways users express their queries or the complexity of the underlying data structures. Users frequently encounter challenges when attempting to translate the user prompt into structured queries, leading to inefficiencies and potential misinterpretations of their intent.

### SUMMARY

The following summary is provided to facilitate an understanding of some of the innovative features unique to the present disclosure and is not intended to be a full description. A full appreciation of the present disclosure may be gained by taking the entire specification, claims, drawings, and abstract as a whole.

In various embodiments of the disclosure, a computer-implemented method for generation of an extended prompt associated with a user prompt is described. The computer-implemented method includes receiving, by a computer, a user prompt comprising a natural language query. The user prompt is received from a user device. The computer-implemented method further includes determining, by the computer, a first set of keywords based on the user prompt and a knowledge base. The first set of keywords includes at least one of a set of domain-specific terms, a set of business logic rules, and context-specific information associated with the user prompt. The knowledge base includes at least one of historical user prompts or one or more business rules. The computer-implemented method further includes applying, by the computer, a language model to the user prompt and the first set of keywords. The computer-implemented method further includes generating, by the computer, an extended prompt based on the application of the language model to the user prompt and the first set of keywords. The computer-implemented method further includes outputting, by the computer, the generated extended prompt.

In various embodiments of the disclosure, a computer system for generation of an extended prompt based on a language model and business knowledge is described. The computer system includes a processor set, a computer-readable storage media, and program instructions that are stored on the one or more computer-readable storage media, the program instructions are executable by the processor set to cause the processor set to receive a user prompt that includes a natural language query. The user prompt is received from a user device. The program instructions further cause the processor set to determine a first set of keywords based on the user prompt and a knowledge base. The first set of keywords includes at least one of a set of domain-specific terms, a set of business logic rules, and context-specific information associated with the user prompt. The knowledge base includes at least one of historical user prompts or one or more business rules. The program instructions further cause the processor set to generate a pseudo dictionary associated with the user prompt and the set of keywords. The pseudo dictionary includes a mapping of the set of keywords to the user prompt. The program instructions further cause the processor set to apply a language model to the pseudo dictionary. The program instructions further cause the processor set to generate an extended prompt based on an application of the language model to the pseudo dictionary. The program instructions further cause the processor set to output the generated extended prompt.

In various embodiments of the disclosure, a computer program product for generation of an extended prompt based on a large language model and business knowledge is described. The computer program product includes a computer-readable storage medium having program instructions stored on the computer-readable storage media to perform operations. The operations include receiving a user prompt comprising a natural language query. The user prompt is received from a user device. The operations further include determining a first set of keywords based on the user prompt and a knowledge base, the first set of keywords includes at least one of a set of domain-specific terms, a set of business logic rules, and context-specific information associated with the user prompt. The knowledge base includes at least one of historical user prompts or one or more business rules. The operations further include applying a language model to the user prompt and the first set of keywords. The operations further include generating an extended prompt based on the application of the language model to the user prompt and the first set of keywords. The operations further include outputting the generated extended prompt.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of an extended prompt based on a language model, in accordance with an embodiment of the disclosure;

FIG. 2 is a diagram that illustrates a network environment for the generation of the extended prompt based on the language model, in accordance with an embodiment of the disclosure;

FIG. 3 is a diagram that illustrates one or more operations performed by the system for the generation of a structured query based on a generator model, in accordance with an embodiment of the disclosure;

FIG. 4 is a diagram that illustrates a method flowchart for generation of a pseudo dictionary based on a similarity score, in accordance with an embodiment of the disclosure;

FIG. 5 is a diagram that illustrates a method flowchart for outputting the structured query, in accordance with an embodiment of the disclosure;

FIG. 6 is a diagram that illustrates a method flowchart for generation of a modified extended prompt based on feedback, in accordance with an embodiment of the disclosure;

FIG. 7 is a diagram that illustrates one or more operations performed by the system for updation of a knowledge base based on prompt data and contextual operational constraints, in accordance with an embodiment of the disclosure;

FIG. 8 is a diagram that illustrates one or more operations performed by the system for the updation of a knowledge base based on a high-frequency prompt, in accordance with an embodiment of the disclosure;

FIG. 9A is a diagram that illustrates an exemplary first user interface for performing structured query generation based on the language model and the business knowledge, in accordance with an embodiment of the disclosure;

FIG. 9B is a diagram that illustrates an exemplary second user interface for performing structured query generation based on the language model and the business knowledge, in accordance with an embodiment of the disclosure;

FIG. 10 is a diagram that illustrates a flowchart of an exemplary method for the generation of the extended prompt based on the language model, in accordance with an embodiment of the disclosure; and

FIG. 11 is a diagram that illustrates a flowchart of an exemplary method for the generation of the extended prompt based on the language model and the pseudo dictionary, in accordance with an embodiment of the disclosure.

### DETAILED DESCRIPTION

In the contemporary landscape of data-driven decision-making, the significance of efficient data analysis and querying cannot be overstated. As enterprises increasingly rely on data to inform their strategies, the emergence of the language models has revolutionized the way of approaching the conversion of natural language queries into structured query commands. Language models help in understanding and generation of complex structured queries with a high degree of accuracy. Traditional methods often depend on rigid rules and templates, which may struggle to accommodate the nuances and variability inherent in natural language.

The present disclosure provides a method for generating structured queries using language models such as a large language model (LLM), such that the method offers several advantages over traditional methods, The LLMs may process natural language inputs and convert them into structured queries, such as Structured Query Language (SQL), with greater speed and accuracy than manual methods. This automation reduces the time and effort for users to formulate queries, allowing them to focus on analyzing results rather than constructing queries. Further, the LLMs leverage vast amounts of training data, which enables them to understand and generate contextually relevant queries. Unlike traditional methods that rely on predefined templates or rules, LLMs may adapt to various contexts and user intents, providing more flexible and dynamic query generation. This adaptability is particularly beneficial in environments where data structures and user requirements frequently change.

Moreover, the LLM provides a more user-friendly experience. Non-expert users, who may lack in-depth knowledge of SQL syntax or database structures, may interact using natural language. This democratization of data access empowers a broader range of users to extract insights from databases without having extensive technical training. As a result, organizations may harness the analytical capabilities of more personnel, leading to better decision-making and increased productivity.

Additionally, LLMs may incorporate contextual operational constraints into their query generation process. For example, LLMs can leverage specific business rules or operational guidelines when formulating queries, ensuring that the generated SQL aligns with organizational standards and requirements. This capability reduces the risk of errors that may arise from manual query construction, where users might overlook critical constraints. Moreover, LLMs may adapt to various contexts and domains, making them particularly valuable in environments where domain-specific knowledge is vital. While traditional systems may falter when faced with specialized terminology or complex queries, LLMs may leverage their extensive training to generate contextually relevant SQL commands. This adaptability not only enhances the accuracy of the generated queries but also empowers users from diverse backgrounds to engage with data more meaningfully. By democratizing access to data analysis, LLMs may foster a culture of data-driven decision-making across entire levels of an organization.

Furthermore, the system may continuously learn and improve from user interactions. By analyzing the effectiveness of generated queries and user feedback, the LLMs may refine and classify the different user prompts and preferences over time. This iterative learning process enhances the quality of query generation, making it more aligned with user expectations and business objectives.

Advantage of the LLM is its potential to reduce the time and resources utilizes for training end users. Traditional approaches often necessitate extensive training programs to help users articulate their query intents effectively. This requirement may be a significant barrier, particularly for organizations with diverse user groups who may have varying levels of technical expertise. In contrast, LLMs may streamline the querying process, allowing users to interact with data more naturally and intuitively. This not only saves time and resources but also enhances user satisfaction and engagement, as individuals may obtain insights without the frustration of navigating complex technical training.

Furthermore, the integration of LLMs into data querying processes may lead to improved collaboration between technical and non-technical teams. By enabling non-technical users to generate SQL queries independently, LLMs may bridge the gap between data analysts and business stakeholders. This collaboration fosters a more agile decision-making process, as insights may be derived and acted upon more swiftly. The ability to generate accurate SQL commands on demand empowers teams to explore data more freely, leading to innovative solutions and strategies that may have otherwise gone unnoticed.

In various embodiments of the disclosure, a computer-implemented method for generation of an extended prompt based on language model and business knowledge is described. The computer-implemented method includes receiving, by a computer, a user prompt comprising a natural language query. The user prompt is received from a user device. The computer-implemented method includes determining, by the computer, a first set of keywords based on the user prompt and a knowledge base. The first set of keywords includes at least one of a set of domain-specific terms, a set of business logic rules, or context-specific information associated with the user prompt. The knowledge base includes at least one of historical user prompts or one or more business rules. The computer-implemented method includes applying, by the computer, a language model to the user prompt and the first set of keywords. The computer-implemented method includes generating, by the computer, an extended prompt based on the application of the language model to the user prompt and the first set of keywords. The computer-implemented method includes outputting, by the computer, the generated extended prompt. The disclosed computer-implemented method provides a systematic approach to generating the extended prompt by leveraging a language model in conjunction with business knowledge. This ensures that the outputted extended prompt incorporates domain-specific terms, business logic rules, and context-specific information, which are vital for accurately addressing user demands. By utilizing these elements, the disclosed computer-implemented method enhances the relevance and precision of the generated prompts, making them more aligned with the specific context in which they are used. Furthermore, the disclosed computer-implemented method generates contextual prompts based on the user prompt, which provides a more tailored response that directly reflects the user's intent. This targeted approach results in more precise prompts, ultimately leading to improved user satisfaction and more effective data retrieval.

In various embodiments of the disclosure, the extended prompt corresponds to a pseudo-structured query. The disclosed computer-implemented method includes generating the pseudo-structured queries which provide a clear and organized format for expressing complex user prompts. The pseudo-structured query optimes the user prompt which results in faster response times and reduced computational overhead, which is particularly beneficial in environments with large datasets or complex user prompt. The pseudo-structured queries can encapsulate complex logic and relationships that may be difficult to express in simple natural language.

In various embodiments of the disclosure, the computer-implemented method further includes applying, by the computer, a generator model to the generated extended prompt. The computer-implemented method further includes generating, by the computer, a structured query based on the application of the generator model to the generated extended prompt. The computer-implemented method further includes outputting, by the computer, the structured query. The disclosed computer implemented method includes generating the structured query based on the extended prompt, which is significantly advantageous for query generation, increasing the accuracy of the structured queries, handling complex logic associated with the user prompt, streamlining workflows, improving performance, facilitating iterative refinement, and ensuring consistency in query structure. Furthermore, the generator model utilizes structured approach which improves the accuracy of the outputs and also ensures that the provided structured query is consistent with the established business logic and user requirements

In various embodiments of the disclosure, the computer-implemented method further includes determining, by the computer, a confidence score associated with the structured query. The confidence score is indicative of a contextual accuracy of the structured query based on at least one of the set of domain-specific terms, the set of business logic rules, or the context-specific information. The computer-implemented method further includes comparing, by the computer, the confidence score associated with the structured query with a threshold confidence score. The computer-implemented method further includes outputting, by the computer, the structured query based on the comparison. The disclosed computer-implemented method includes the determination of a confidence score associated with the structured query thereby providing a measure to assess the reliability and effectiveness of the structured queries. The disclosed computer-implemented method evaluates the contextual accuracy of the structured query based on domain-specific terms, business logic rules, and context-specific information. This allows to check how well the structured query aligns with the user prompt. This minimizes the risk of executing inaccurate or irrelevant queries, thereby improving the quality of the results returned to the user.

In various embodiments of the disclosure, the computer-implemented method further includes receiving, by the computer, feedback associated with the outputted structured query. The feedback is received from the user device. The computer-implemented method further includes determining, by the computer, an updated set of keywords based on the feedback. The computer-implemented method further includes applying, by the computer, the language model to the feedback and the updated set of keywords. The computer-implemented method further includes generating, by the computer, an updated extended prompt based on the application of the language model to the feedback and the updated set of keywords. The computer-implemented method further includes applying, by the computer, the generator model to the updated extended prompt. The computer-implemented method further includes generating, by the computer, an updated structured query based on the application of the generator model to the updated extended prompt. The computer-implemented method further includes outputting, by the computer, the updated structured query. The disclosed computer-implemented method includes the feedback loop, by actively receiving feedback from users regarding the outputted structured query which allows better alignment with user expectations and appropriate contextual information. The disclosed computer-implemented helps to increase the accuracy of the structured query by iterative process, which culminates in the application of a generator model to generate the updated structured query, that is more relevant to the user prompt. Hence, the disclosed computer-implemented method enhances the accuracy of the outputted structured query.

In various embodiments of the disclosure, the computer-implemented method further includes extracting, by the computer, feature data associated with the user prompt. The feature data comprise at least domain-specific data or business terms. The computer-implemented method further includes determining, by the computer, a first vector associated with the feature data. The computer-implemented method further includes determining, by the computer, a second vector associated with the first set of keywords. The computer-implemented method further includes calculating, by the computer, a similarity score that indicates a degree of similarity between the first vector and the second vector. The computer-implemented method further includes generating, by the computer, a pseudo dictionary based on the determination of the similarity score. The pseudo dictionary includes a mapping of the first set of keywords to the user prompt. The disclosed computer-implemented method further includes generation of the pseudo dictionary based on the set of keywords and the user prompt. The determination of vectors for both the feature data and the set of keywords allows for a quantitative assessment of similarity. The disclosed computer-implemented provides classification of the relationships between user prompt and relevant terms, improving the quality of the generated queries. The generation of a pseudo dictionary that maps the set of keywords to user prompt provides a structured framework for interpreting queries.

In various embodiments of the disclosure, the computer-implemented method further includes applying, by the computer, the language model to the pseudo dictionary. The computer-implemented method further includes generating, by the computer, the extended prompt based on the application of the language model to the pseudo dictionary. The computer-implemented method further includes outputting the generated extended prompt to the generator model. The outputting corresponds to transmission of the extended prompt to the generator model. The disclosed computer-implemented method leverages the structured mapping of keywords to user prompts, to generate an extended prompt that is contextually relevant and also enriched with domain-specific terminology and business logic. This ensures that the extended prompt captures the nuances of user intent more accurately, leading to improved query generation and more precise data retrieval.

In various embodiments of the disclosure, the computer-implemented method further includes receiving, by the computer, prompt data associated with one or more prompts. The one or more prompts includes the user prompt. The computer-implemented method further includes transforming, by the computer, the prompt data into a first dictionary associated with the knowledge base. The first dictionary includes a mapping of the prompt data to the first set of keywords. The computer-implemented method further includes updating, by the computer, the knowledge base based on the first dictionary. The disclosed computer-implemented method streamlines the knowledge base by mapping the prompt data to the first set of keywords, thereby establishing a structured reference that not only allows for quicker access to relevant information but also helps to establish a relationship with the business domain. This structured reference reduces the computational overhead typically associated with processing user prompts, as the computer-implemented method can utilize pre-mapped keywords rather than performing extensive searches through unorganized data. Consequently, this leads to faster processing times and more responsive interactions, enabling users to receive timely and accurate results. By aligning the keywords with the specific terminology and context of the business domain, the computer-implemented method enhances the relevance and applicability of the information retrieved, ensuring that users receive insights that are not only accurate but also contextually appropriate for the user demands.

In various embodiments of the disclosure, the computer-implemented method further includes identifying, by the computer, a high-frequency prompt from the one or more prompts based on count data associated with each prompt of the one or more prompts. The computer-implemented method further includes determining, by the computer, a second set of keywords associated with the high-frequency prompt. The computer-implemented method further includes transforming, by the computer, the prompt data into a second dictionary associated with the knowledge base. The second dictionary includes a mapping of the high-frequency prompt to the second set of keywords. The computer-implemented method further includes updating, by the computer, the knowledge base based on the second dictionary. The disclosed computer-implemented method includes the identification of high-frequency prompts, which are user inputs that occur frequently within a given context or dataset. By recognizing these high-frequency prompts, the disclosed computer-implemented method can create a second dictionary that significantly enhances the ability to deliver consistent and reliable responses to similar user queries. High-frequency prompts are relevant because they often reflect common user demands and inquiries, allowing to prioritize and optimize its responses based on actual usage patterns. This structured approach ensures that when users submit similar prompts, the disclosed computer-implemented method can quickly reference the second dictionary to generate responses that are not only accurate but also uniform across different interactions.

In various embodiments of the disclosure, the computer-implemented method further includes receiving, by the computer, one or more contextual operational constraints comprising the one or more business rules and one or more input enhancement rules. The computer-implemented method further includes updating, by the computer, the knowledge base based on the received one or more contextual operational constraints. The disclosed computer-implemented method includes the contextual operational constraints, including business rules and input enhancement rules, which ensures that the structured query is within defined parameters that align with organizational goals and user expectations. The generation of the structured query adheres to specific operational guidelines, thereby enhancing compliance and relevance. Furthermore, by continuously updating the knowledge base with the contextual operational constraints, the disclosed computer-implemented method remains agile and responsive to changes in business rules or user demands, allowing for ongoing optimization of performance and user satisfaction.

In various embodiments of the disclosure, a computer system for generation of an extended prompt based on a language model and a business knowledge is described. The computer system includes a processor set, a computer-readable storage media, and program instructions that are stored on the one or more computer-readable storage media, the program instructions are executable by the processor set to cause the processor set to receive a user prompt that includes a natural language query. The user prompt is received from a user device. The program instructions further cause the processor set to determine a first set of keywords based on the user prompt and a knowledge base. The first set of keywords includes at least one of a set of domain-specific terms, a set of business logic rules, and context-specific information associated with the user prompt. The knowledge base includes at least one of historical user prompts or one or more business rules. The program instructions further cause the processor set to generate a pseudo dictionary associated with the user prompt and the set of keywords. The pseudo dictionary includes a mapping of the set of keywords to the user prompt. The program instructions further cause the processor set to apply a language model to the pseudo dictionary. The program instructions further cause the processor set to generate an extended prompt based on an application of the language model to the pseudo dictionary. The program instructions further cause the processor set to output the generated extended prompt. The disclosed system provides a systematic approach for generating the extended prompt by leveraging a language model in conjunction with business knowledge. This ensures that the outputted extended prompt incorporates domain-specific terms, business logic rules, and context-specific information, which are vital for accurately addressing user demands. By utilizing these elements, the disclosed system enhances the relevance and precision of the generated prompts, making them more aligned with the specific context in which they are used. Furthermore, the disclosed system generates contextual prompts based on the user prompt, which provides a more tailored response that directly reflects the user's intent. This targeted approach results in more precise prompts, ultimately leading to improved user satisfaction and more effective data retrieval.

In various embodiments of the disclosure, the extended prompt corresponds to a pseudo-structured query. The disclosed system includes generating the pseudo structured queries which provides a clear and organized format for expressing complex user prompts. The pseudo structured query optimes the user prompt which results in faster response times and reduced computational overhead, which is particularly beneficial in environments with large datasets or complex user prompt. The pseudo structured queries can encapsulate complex logic and relationships that may be difficult to express in simple natural language.

In various embodiments of the disclosure, the program instructions further cause the processor set to apply a generator model to the extended prompt. The program instructions further cause the processor set to generate a structured query based on the application of the generator model to the generated extended prompt. The program instructions further cause the processor set to output the structured query. The disclosed system includes generating the structured query based on the extended prompt, significantly advantageous for query generation, increasing accuracy of the structured queries, handling complex logic associated with the user prompt, streamlining workflows, improving performance, facilitating iterative refinement, and ensuring consistency in query structure. Furthermore, the generator model utilizes structured approach which improves the accuracy of the outputs and also ensures that the provided structured query is consistent with the established business logic and user requirements.

In various embodiments of the disclosure, the program instructions further cause the processor set to determine a confidence score associated with the structured query. The confidence score is indicative of a contextual accuracy of the structured query based on at least one of the set of domain-specific terms, the set of business logic rules, or the context-specific information. The program instructions further cause the processor set to compare the confidence score associated with the structured query with a threshold confidence score. The program instructions further cause the processor set to output the structured query based on the comparison. The disclosed system includes the determination of a confidence score associated with the structured query thereby providing a measure to assess the reliability and effectiveness of the structured queries. The disclosed system evaluates the contextual accuracy of the structured query based on domain-specific terms, business logic rules, and context-specific information. This allows the disclosed system to check how well the structured query aligns with the user prompt. This minimizes the risk of executing inaccurate or irrelevant queries, thereby improving the quality of the results returned to the user.

In various embodiments of the disclosure, the program instructions further cause the processor set to receive feedback associated with the outputted structured query. The feedback is received from the user device. The program instructions further cause the processor set to determine an updated set of keywords based on the feedback. The program instructions further cause the processor set to apply the language model to the feedback and the updated set of keywords. The program instructions further cause the processor set to generate an updated extended prompt based on the application of the language model to the feedback and the updated set of keywords. The program instructions further cause the processor set to apply the generator model to the updated extended prompt. The program instructions further cause the processor set to generate an updated structured query based on the application of the generator model to the updated extended prompt. The program instructions further cause the processor set to output the updated structured query. The disclosed system includes the feedback loop, by actively receiving feedback from users regarding the outputted structured query which allows better alignment with user expectations and appropriate contextual information. The disclosed system helps to increase the accuracy of the structured query by an iterative process, which culminates in the application of a generator model to generate the updated structured query that is more relevant to the user prompt. Hence, the disclosed system enhances the accuracy of the outputted structured query.

In various embodiments of the disclosure, the program instructions further cause the processor set to extract feature data associated with the user prompt. The feature data comprise at least domain-specific data or business terms. The program instructions further cause the processor set to determine a first vector associated with feature data. The program instructions further cause the processor set to determine a second vector associated with the set of keywords. The program instructions further cause the processor set to calculate a similarity score that indicates a degree of similarity between the first vector and the second vector. The program instructions further cause the processor set to generate the pseudo dictionary based on the determination of the similarity score. The pseudo dictionary includes the set of keywords mapped to the user prompt. The disclosed computer-implemented method further includes generation of the pseudo dictionary based on the set of keywords and the user prompt. The determination of vectors for both the feature data and the set of keywords allows for a quantitative assessment of similarity. The disclosed computer-implemented method provides classification of the relationships between user prompt and relevant terms, improving the quality of the generated queries. The generation of a pseudo dictionary that maps the set of keywords to user prompt provides a structured framework for interpreting queries.

In various embodiments of the disclosure, the program instructions further cause the processor set to receive prompt data associated with one or more prompts. The one or more prompts include the user prompt. The program instructions further cause the processor set to transform the prompt data into a first dictionary associated with the knowledge base. The first dictionary includes the prompt data mapped to the set of keywords. The program instructions further cause the processor set to update the knowledge base based on the first dictionary. The disclosed system streamlines the knowledge base by mapping the prompt data to the first set of keywords, thereby establishing a structured reference that not only allows for quicker access to relevant information but also helps to establish a relationship with the business domain. This structured reference reduces the computational overhead typically associated with processing user prompts, as the disclosed system can utilize pre-mapped keywords rather than performing extensive searches through unorganized data. Consequently, this leads to faster processing times and more responsive interactions, enabling users to receive timely and accurate results. By aligning the keywords with the specific terminology and context of the business domain, the disclosed system enhances the relevance and applicability of the information retrieved, ensuring that users receive insights that are not only accurate but also contextually appropriate for the user demands.

In various embodiments of the disclosure, the program instructions further cause the processor set to identify a high-frequency prompt from the one or more prompts based on count data associated with each prompt of the one or more prompts. The program instructions further cause the processor set to determine a second set of keywords associated with the high-frequency prompt. The program instructions further cause the processor set to transform the prompt data into a second dictionary associated with the knowledge base. The second dictionary includes the high-frequency prompt mapped to the second set of keywords. The program instructions further cause the processor set to update the knowledge base based on the second dictionary. The disclosed system includes the identification of high-frequency prompts, which are user inputs that occur frequently within a given context or dataset. By recognizing these high-frequency prompts, the disclosed system can create a second dictionary that significantly enhances the ability to deliver consistent and reliable responses to similar user queries. High-frequency prompts are relevant because they often reflect common user demands and inquiries, allowing the disclosed system to prioritize and optimize its responses based on actual usage patterns. This structured approach ensures that when users submit similar prompts, the disclosed system can quickly reference the second dictionary to generate responses that are not only accurate but also uniform across different interactions.

In various embodiments of the disclosure, the program instructions further cause the processor set to receive one or more contextual operational constraints that includes the one or more business rules or one or more input enhancement rules. The program instructions further cause the processor set to update the knowledge base based on the received one or more contextual operational constraints. The disclosed system includes the contextual operational constraints, including business rules and input enhancement rules, which ensure that the structured query is within defined parameters that align with organizational goals and user expectations. The generation of the structured query adheres to specific operational guidelines, thereby enhancing compliance and relevance. Furthermore, by continuously updating the knowledge base with the contextual operational constraints, the disclosed system remains agile and responsive to changes in business rules or user demands, allowing for ongoing optimization of performance and user satisfaction.

In various embodiments of the disclosure, a computer program product for generation of an extended prompt based on a large language model and business knowledge is described. The computer program product includes a computer-readable storage medium having program instructions stored on the computer-readable storage media to perform operations. The operations include receiving a user prompt comprising a natural language query. The user prompt is received from a user device. The operations further include determining a first set of keywords based on the user prompt and a knowledge base, the first set of keywords includes at least one of a set of domain-specific terms, a set of business logic rules, and context-specific information associated with the user prompt. The knowledge base includes at least one of historical user prompts or one or more business rules. The operations further include applying a language model to the user prompt and the first set of keywords. The operations further include generating an extended prompt based on the application of the language model to the user prompt and the first set of keywords. The operations further include outputting the generated extended prompt. The disclosed computer program product provides a systematic approach to generating the extended prompt by leveraging a language model in conjunction with business knowledge. This ensures that the outputted extended prompt incorporates domain-specific terms, business logic rules, and context-specific information, which are vital for accurately addressing user demands. By utilizing these elements, the disclosed computer program product enhances the relevance and precision of the generated prompts, making them more aligned with the specific context in which they are used. Furthermore, the disclosed computer program product generates contextual prompts based on the user prompt, which allows for a more tailored response that directly reflects the user's intent. This targeted approach results in more precise prompts, ultimately leading to improved user satisfaction and more effective data retrieval.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations may be performed in a different order than what is shown in each flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

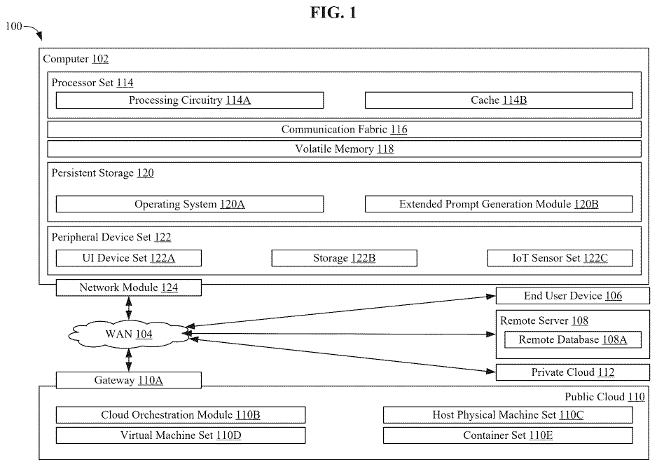

FIG. 1 is a diagram that illustrates a computing environment for generation of an extended prompt based on a language model, in accordance with an embodiment of the disclosure. With reference to FIG. 1, there is shown a computing environment 100 that contains an example of an environment for the execution of at least some of the computer code involved in performing the disclosed methods, such as an extended prompt generation module 120B. In addition to the extended prompt generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the extended prompt generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the storage media discussed below. The program instructions, and associated data, are accessed by the processor set 114 to control and direct the performance of the disclosed methods. In computing environment 100, at least some of the instructions for performing the disclosed methods may be stored in the dynamic modification of the extended prompt generation module 120B in persistent storage 120.

Communication fabric 116 is the signal conduction path that allows the various components of computer 102 to interact and exchange information. Typically, this fabric is made of switches and electrically conductive paths, such as the switches and electrically conductive paths that make up buses, bridges, physical input/output ports, and the like. Types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not vital unless affirmatively indicated. In the computer 102, the volatile memory 118 is located in a single package and is internal to the computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the extended prompt generation module 120B typically includes at least some of the computer code involved in performing the disclosed methods.

The peripheral device set 122 includes the set of peripheral devices of computer 102. Data communication connections between the peripheral devices and the components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is vital to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, a first sensor may be a thermometer, and a second sensor may be a motion detector.

The network module 124 is the collection of computer software, hardware, and firmware that allows computer 102 to communicate with the computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 may display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or the computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs may be stored as “images”. A new active instance of the VCE may be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize theresources of that computer, such as connected devices, files and folders, network shares, CPU power, and quantifiable hardware capabilities. However, programs running inside a container may only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

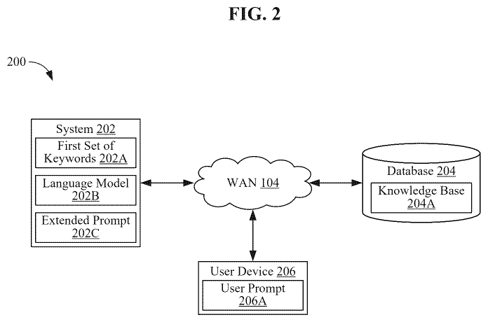

FIG. 2 is a diagram that illustrates a network environment 200 for the generation of an extended prompt 202C based on a language model 202B, in accordance with an embodiment of the disclosure. FIG. 2 is explained in conjunction with elements from FIG. 1. With reference to FIG. 2, there is shown a diagram of a network environment 200. The network environment 200 includes a computer system 202 (hereinafter referred to as a system 202). The system 202 includes a first set of keywords 202A, the language model 202B, and the extended prompt 202C. The network environment 200 further includes a database 204. The database 204 further includes a knowledge base 204A. The network environment 200 further includes a user device 206. The user device 206 further includes a user prompt 206A. The network environment 200 further includes the WAN 104 of FIG. 1. In an example, the system 202 is an exemplary embodiment of the computer 102 in FIG. 1.

The system 202 may include suitable logic, circuitry, interfaces, and/or code that may be configured to receive the user prompt 206A comprising a natural language query. The user prompt 206A is received from the user device 206. The system 202 is further configured to determine the first set of keywords 202A based on the user prompt 206A and the knowledge base 204A, the first set of keywords 202A comprising at least one of a set of domain-specific terms, a set of business logic rules, and context-specific information associated with the user prompt 206A. The knowledge base 204A includes at least one of historical user prompts or one or more business rules. The system 202 is further configured to apply the language model 202B to the user prompt 206A and the first set of keywords 202A. The system 202 is further configured to generate the extended prompt 202C based on the application of the language model 202B to the user prompt 206A and the first set of keywords 202A. The system 202 is further configured to output the generated extended prompt 202C associated with the user prompt 206A.

Examples of the system 202 include, but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the system 202 may be embodied as a cloud-based service, a cloud-based application, a cloud-based platform, a remote server-based service, a remote server-based application, a remote server-based platform, or a virtual computing system.

In an embodiment, the database 204 is a structured collection of data that enables efficient storage, retrieval, and management of information, often organized in a way that provides easy access and manipulation. Typically stored electronically in a computer system 202, the databases are structured to facilitate quick access and manipulation of data through a Database Management System (DBMS). In an embodiment, the system 202 may utilize the database 204 to store and manage data associated with the generation of the structured query. By way of example, and not by limitation, the database 204 includes a repository that integrates various types of information vital for the generation of extended prompt based on the business knowledge. The database 204 is configured to store the knowledge base 204A. The database 204 stores the set of keywords associated with historical user prompt. In an embodiment, the database 204 is configured to store the extended prompt 202C generated by the system 202. In an example, the extended prompt 202C are enriched natural language queries that provide additional context or specifications for the intended SQL command. The database 204 stores various versions of extended prompts, allowing the system 202 to learn from user interactions and improve its understanding of user intent over time. This adaptability enhances the accuracy of generated structured queries. In an embodiment, the database 204 is configured to store the structured query generated by the system 202. The structured query is stored with a specific type of query or business scenario, enabling the system 202 to quickly reference and utilize the structured query as the situation demands.

The user device 206 includes suitable logic, circuitry, and/or interfaces that are configured to execute one or more tasks within the network environment 200. The user device 206 performs the one or more tasks such as receiving data, processing the data, and transmitting the data. In an embodiment of the disclosure, the system 202 receives the user prompt 206A from the user device 206. The user prompt 206A includes the natural language query provided by a user associated with the user device 206. In an embodiment of the disclosure, the system 202 receives feedback associated with the structured query from the user device 206. In an embodiment of the disclosure, the system 202 outputs the at least one of the extended prompt 202C or the structured query on the user device 206. Examples of the user device 206 include one of but are not limited to, a smartphone, a cellular phone, a mobile phone, a consumer electronic (CE) device, an Internet of Things (IoT) device, a computing device, a mainframe machine, a server, a computer workstation, or the like.

By way of example, and not by limitation, the language model 202B leverages natural language processing (NLP) and machine learning techniques to understand, generate, and manipulate human language. For example, the language model 202B may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain must be carried out. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping the majority of the base model's parameters frozen. In particular, the adapter is used to fine-tune the base model for a specific downstream task without extensively modifying its pre-trained parameters. This approach is beneficial when computational resources or labeled task-specific data are limited.

In operation, the system 202 is configured to receive the user prompt 206A comprising the natural language query. The user prompt 206A is received from the user device 206. In an example, the system 202 is configured to receive the user prompt 206A associated with the user. The user prompt 206A is transmitted from the user device 206, such as a smartphone, tablet, or computer, allowing users to engage with the system 202 in a conversational manner. In an embodiment, the user prompt 206A may include a question associated with a schema. In an example, the schema may be associated with an organizational database. This allows the users to seek information about the structure, relationships, and data types within the organizational database. For instance, the user might inquire about the fields available in a particular table, the relationships between different tables, or the constraints applied to certain data entries. By understanding the user prompt, the system 202 provides valuable insights that facilitate data management and decision-making processes.

Further, the system 202 is configured to determine the first set of keywords 202A based on the user prompt 206A and the knowledge base 204A. The first set of keywords 202A includes at least one of a set of domain-specific terms, a set of business logic rules, and context-specific information associated with the user prompt 206A. The knowledge base 204A includes at least one of historical user prompts or one or more business rules. In an embodiment, the system 202 is configured to determine the first set of keywords 202A derived from the user prompt 206A in conjunction with the knowledge base 204A. This first set of keywords 202A is utilized for accurately interpreting user intent received from the user prompt 206A and facilitating effective responses. The first set of keywords 202A includes the domain-specific terms that are relevant to the subject matter of inquiry by the user through the user prompt 206A, business logic rules that guide decision-making processes, and context-specific information that pertains to the user prompt 206A. The knowledge base 204A includes historical user prompts that provide insights into past interactions with the one or more users and preferences, as well as established business rules that dictate how certain queries should be handled. By analyzing this information, the system 202 identifies key terms and concepts that are most pertinent to the request from the user received from the user prompt 206A. For example, if the user prompt 206A involves a request for sales data, the system 202 may determine the first set of keywords 202A related to sales metrics, relevant business rules for data aggregation, and any specific context provided by the user. The structured approach enables the system 202 to generate more accurate and contextually relevant responses, ultimately enhancing the user experience and ensuring that inquiries are addressed effectively.

Further, the system 202 is configured to apply the language model 202B to the user prompt 206A and the first set of keywords 202A. In an example, the application of the language model 202B enhances understanding of the system 202 about the intent of the user and generating coherent, contextually appropriate responses. By leveraging the language model 202B, the system 202 analyzes the structure and semantics of the user prompt 206A in conjunction with the determined first set of keywords 202A. This dual analysis allows the system 202 to capture nuances in language, such as variations in phrasing, synonyms, and contextual meanings that may not be immediately apparent from the first set of keywords 202A alone. For instance, if the user asks, “What are the total sales for this quarter?” the language model 202B recognizes that “total sales” and “this quarter” are critical components of the inquiry, even if the specific keywords differ from those in the knowledge base.

The integration of the language model 202B provide a more sophisticated interpretation of the user prompt 206A, enabling the system 202 to generate responses that are accurate and relevant to the user's specific context. This capability significantly enhances the overall user experience, as it allows for more natural and intuitive interactions, ultimately leading to more effective communication between the user and the system 202.

Further, the system 202 is configured to generate the extended prompt 202C based on the application of the language model 202B to the user prompt 206A and the first set of keywords 202A. In an example, the extended prompt 202C corresponds to a pseudo-structured query associated with the user prompt 206A. In an example, the system 202 is configured to generate the extended prompt 202C, by applying the language model 202B to the user prompt 206A and the first set of keywords 202A. This transforms the user prompt 206A into a structured format that may be effectively processed by the system. The extended prompt 202C corresponds to the pseudo-structured query, which means it retains the essence of the user's original request while organizing it in a way that aligns with the system's processing capabilities. For instance, if the user inputs a prompt like, “Can you provide the sales figures for last month?” the system analyzes this prompt alongside the relevant keywords, such as “sales figures” and “last month.” The language model 202B then synthesizes this information to create the extended prompt 202C that delineates the parameters of the query.

This extended prompt 202C not only clarifies the user's intent but also incorporates any contextual nuances identified during the analysis. By structuring the query in this manner, the system 202 enhances its ability to retrieve accurate and relevant data from the knowledge base 204A. The generation of the extended prompt 202C is a pivotal operation in the overall process, as it bridges the gap between natural language input and the structured data retrieval mechanisms of the system, ultimately leading to more precise and meaningful responses for the user.

Further, the system 202 is configured to generate the extended prompt. In an example, the generated extended prompt 202C is stored in the database 204. In an example, the system 202 is configured to generate the extended prompt 202C, which is a refined version of the user's original inquiry (e.g., the user prompt 206A). Once created, the extended prompt 202C is stored in the database 204 for future reference and processing. Storing the extended prompt 202C allows the system 202 to maintain a record of user interactions, which may be utilized for analyzing trends, improving response accuracy, and enhancing the overall user experience.

In addition to storing the extended prompt 202C, the system 202 is configured to generate a structured query based on the generated extended prompt 202C. The structured query translates the extended prompt 202C into a format that may be easily processed by the system's underlying data retrieval mechanisms. By converting the extended prompt 202C into the structured query, the system 202 may efficiently access relevant information from the knowledge base 204A or other data sources.

For example, if the extended prompt 202C indicates a request for sales data for a specific time period, the structured query will be formulated to directly target the relevant database fields, ensuring that the system 202 retrieves the most accurate and pertinent information. This process of creating an extended prompt 202C and then generating the structured query enhances the system's ability to respond effectively to user inquiries, ultimately leading to a more streamlined and satisfying user experience.

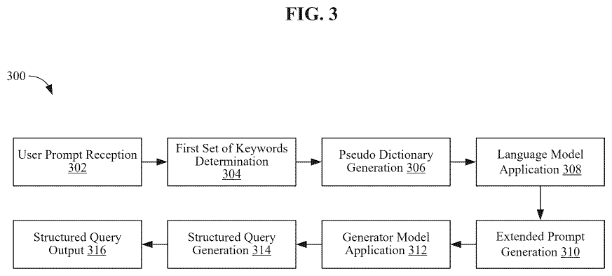

In an embodiment, the system 202 includes additional components for enabling the generation of extended prompt. These component are further shown in conjunction with FIG. 3.

FIG. 3 is a diagram that illustrates a block diagram 300 of one or more operations performed by the system 202 for the generation of structured query based on the extended prompt 202C, in accordance with an embodiment of the disclosure. FIG. 3 is explained in conjunction with elements from FIG. 1, and FIG. 2. With reference to FIG. 3, the operations may start at 302.

At 302, a user prompt reception operation is executed. In the user prompt reception operation, the system 202 is configured to receive the user prompt 206A including the natural language query. The user prompt 206A is received from the user device 206. In an example, the user associated with the user device 206 wants to extract the data from the organizational database. The system 202 receives the user prompt 206A from the user device 206. In an example, the user prompt 206A is “total sales in last quarter”. This user prompt 206A reflects the user's intent to extract relevant data from the organizational database, such as a sales summary for the previous quarter. The system 202 provides a method that allows the user to provide the user prompt 206A in the natural language rather than the structured query syntax. In an embodiment, the system 202 can also receive user prompts 206A from other sources, such as voice-activated assistants, chatbots, or external applications that interface with the organizational database. This flexibility in prompt reception enables a broader range of user interaction The system 202 processes the user prompt 206A and converting into a format that aligns with the organizational database schema.

At 304, a first set of keywords determination operation is executed. In the set of determination operation, the system 202 is configured to determine the set of keywords 202A based on the user prompt 206A and the knowledge base 204A, the first set of keywords 202A includes at least one of a set of domain-specific terms, a set of business logic rules, and context-specific information associated with the user prompt 206A. The knowledge base 204A includes at least one of historical user prompts or one or more business rules. In an example, the system 202 identifies and extracts the set of keywords 202A that are relevant to the user prompt 206A, leveraging the information stored in the knowledge base 204A. The set of keywords 202A identified is vital for understanding the user's intent and for guiding the subsequent data retrieval processes.

The determination of the set of keywords 202A includes analyzing the user prompt 206A in conjunction with the knowledge base 204A, which contains valuable resources such as historical user prompts and established business rules. By utilizing the knowledge base 204A, the system 202 contextualizes the user prompt 206A and extracts the set of keywords 202A that are not only relevant but also aligned with the specific domain of inquiry by the user. The first set of keywords 202A may include domain-specific terms, business logic rules, and context-specific information that directly relates to the user's request.

For example, if the user prompt 206A is “total sales in the last quarter,” the system 202 employs a natural language processing (NLP) model to analyze the user prompt 206A. The NLP model breaks down the sentence structure, identifies key components, and discerns the underlying intent. In this case, the determined set of keywords may include “total sales,” “last quarter,” and contextual terms such as, but not limited to, “financial performance” or “sales metrics.”. The use of domain-specific terms is vital in business contexts, where precise language may significantly impact the interpretation of a query. By recognizing terms that are specific to the organization's operations, the system 202 ensures that the set of keywords 202A aligns with the relevant data fields in the organizational database. For instance, “total sales” may correspond to a specific database field that aggregates sales figures, while “last quarter” may be linked to a time frame filter in the data retrieval process. Moreover, the incorporation of business logic rules into the set of first keyword determination processes enhances the ability of the system 202 to generate accurate and contextually appropriate responses. For instance, business rules may dictate how sales data is calculated, reported, or analyzed, and by integrating these rules into the first set of keywords 202A determination processes, the system 202 ensures that the user's request is handled in accordance with organizational standards and practices. Further, the context-specific information associated with the user prompt 206A may include user history, previous interactions, or specific preferences that the system 202 has learned over time. By considering this context, the system 202 refined the set of keywords 202A further, tailoring the response to demands and expectations of the individual user.

At 306, a pseudo dictionary generation operation is executed. In the pseudo dictionary generation operation, the system 202 is configured to generate the pseudo dictionary including a mapping of the first set of keywords 202A and the user prompt 206A. In an example, the system 202 is configured to create a pseudo dictionary that establishes the mapping between the first set of keywords 202A and the user prompt 206A.

The pseudo dictionary serves as a reference framework that links the determined first set of keywords 202A to the specific context of the user's query. By creating this mapping, the system 202 may better understand the relationships between the first set of keywords 202A and the overall intent of the user prompt. For instance, if the user prompt 206A is “total sales in the last quarter,” and the identified keywords include “total sales” and “last quarter,” the pseudo dictionary will document these associations, allowing the system 202 to recognize how these terms relate within the context of the query. For example, the system 202 may generate more accurate and contextually relevant queries to the organizational database. Additionally, the pseudo dictionary may facilitate the application of business logic rules and domain-specific knowledge, ensuring that the responses generated align with organizational standards.

At 308, a language model application operation is executed. In the language model application operation, the system 202 is configured to apply the language model 202B to the pseudo dictionary. In an example, the language model 202B may allow the system 202 to understand the user prompt 206A and facilitate accurate data retrieval from the organizational database. The language model 202B, which may be based on advanced natural language processing (NLP) techniques, is configured to comprehend and generate human-like text. By applying the language model 202B to the pseudo dictionary, the system 202 leverages its capabilities to interpret the relationships between the first set of keywords 202A and the user prompt 206A more effectively. The pseudo dictionary serves as the structured reference that informs the language model 202B about the specific context and intent behind the user prompt 206A.

By way of example, and not by limitation, if the pseudo dictionary maps the first set of keywords 202A like “total sales” and “last quarter” to the user prompt 206A “total sales in the last quarter,” the language model 202B utilizes this information to generate the extended prompt 202C that accurately reflects the user's intent. The language model 202B may determine synonyms or related terms, which may not have been explicitly stated in the user prompt 206A.

Furthermore, the application of the language model 202B allows the system 202 to generate more nuanced and contextually appropriate responses. The language model 202B may consider various factors, such as the user's previous interactions, preferences, and the specific business logic rules that apply to the user prompt. This results in a more personalized and relevant output, enhancing the overall user experience.

At 310, an extended prompt generation operation is executed. In the extended prompt generation operation, the system 202 is configured to generate the extended prompt 202C based on the application of the language model 202B to the pseudo dictionary. In an example, the extended prompt 202C may correspond to the pseudo-structured query associated with the user prompt 206A. By way of example, and not by limitation, the system 202 is configured to generate the extended prompt 202C that reflects a more detailed and structured interpretation of the user prompt 206A, based on the application of the language model 202B to the pseudo dictionary.

The extended prompt 202C serves as a refined version of the user's initial query, incorporating the relationships and context established in the pseudo dictionary. By leveraging the capability of the language model 202B, the system 202 transforms the first set of keywords 202A and their mappings into a more comprehensive and structured query format. This extended prompt 202C is designed to capture the full intent of the user's request, ensuring that relevant aspects are addressed.

For instance, if the user prompt 206A is “total sales in the last quarter,” the extended prompt 202C might be formulated as the pseudo-structured query that specifies the exact parameters for data retrieval. This could include details such as the time frame (last quarter), the type of data requested (total sales), and any additional filters or conditions that may apply, such as geographical regions or product categories.

The generation of the extended prompt 202C provides accurate data retrieval from the underlying database or knowledge base. By providing the structured query that aligns with the business logic and data schema, the system 202 may ensure that the response generated is not only relevant but also precise and actionable.

By way of example, and not by limitation, if the user prompt 206A is “How many blocked DO alerts totally in the SLO” the system 202 determines the first set of keywords 202A associated with this user prompt 206A and the knowledge base 204A. Further knowledge base 204A may store the business rule associated with the first set of keywords. For instance, the business rule associated with the first set of keywords 202A is:
“Blocked DO alert: Using BLOCKED_DO_FLAG=1 and DISTINCT DO_NUMBER) in the ORDER_CURRENT_ALERT_INFO only for current open alert OR Using ALERT_TYPE=‘Blocked DO’ and DISTINCT SALES_DOCUMENT in the ORDER_ALERT_HISTORY for the alert in the history including the closed/open alert. SLO: SBU=‘SLO’” The business knowledge specifies that “Blocked DO alert” may be identified using two criteria: either by setting BLOCKED_DO_FLAG=1 and counting distinct DO_NUMBER in the ORDER_CURRENT_ALERT_INFO for current open alerts, or by using ALERT_TYPE=‘Blocked DO’ and counting distinct SALES_DOCUMENT in the ORDER_ALERT_HISTORY for alerts, both closed and open. Additionally, the SLO condition is defined as SBU=‘SLO’.

Further, the system 202 generates the extended prompt 202C as “How many blocked DO alerts totally in the SLO Thereinto, the alerts indicate Where Alert type=‘Blocked DO’ and Count (DISTINCT SALES_DOCUMENT) to get number, SLO indicates the Where SBU=‘SLO’” The extended his prompt indicates that the query should filter for alerts where ALERT_TYPE=‘Blocked DO and count the distinct SALES_DOCUMENT. Furthermore, it specifies that the SLO condition requires filtering with SBU=‘SLO’. This structured approach ensures that the system 202 retrieves accurate data, providing the user with a precise count of blocked DO alerts relevant to the SLO context.

At 312, a generator model application operation is executed. In the generator model operation, the system 202 is configured to apply the generator model to the generated extended prompt. In an example, the generator model corresponds to text to sequel model. In an example, the generator model is configured to convert natural language prompts into sequel queries, enabling the system 202 to interact effectively with the organization databases.

The extended prompt 202C generated in the previous extended prompt generation operation at 310 serves as the input for the generator model. For instance, if the extended prompt 202C is “How many blocked DO alerts totally in the SLO,” the generator model interprets this natural language request and translates it into a corresponding SQL query. This translation involves understanding the semantics of the prompt, identifying key components such as the type of alert, the conditions for filtering (e.g., ALERT_TYPE=‘Blocked DO’), and the specific context (e.g., SBU=‘SLO’).

This SQL query accurately reflects the user's request, ensuring that the system 202 retrieves the correct data from the database. By applying the generator model, the system 202 not only automates the query generation process but also enhances accuracy and efficiency, allowing users to obtain the information without requiring deep technical knowledge of SQL.

At 314, a structured query generation operation is executed. In the structured query generation operation, the system 202 is configured to generate the structured query based on the application of the generator model to the generated extended prompt. In an example, the system 202 is configured to generate the structured query based on the output produced by the generator model applied to the previously generated extended prompt.

The structured query generation operation takes the SQL query formulated by the generator model and refines it, ensuring that it adheres to the specific syntax and requirements of the underlying database system. This ensure that the query is not only syntactically correct but also optimized for performance and accuracy in retrieving the desired data.

For example, if the generator model has produced a SQL query like:
SELECT COUNT (DISTINCT SALES_DOCUMENT)
FROM ORDER_ALERT_HISTORY
WHERE ALERT_TYPE=‘Blocked DO’
AND SBU=‘SLO’;

The structured query generation operation may involve validating this query against the database schema, checking for the existence of the specified tables and fields, and ensuring that the conditions are logically sound. Additionally, the system 202 may optimize the query by adding indexes or restructuring it to enhance execution speed. Once the structured query is finalized, it is prepared for execution against the database. This structured query serves as a precise instruction set that the database management system may interpret to retrieve the relevant data.

At 316, the structure query output operation is executed. In the structure query output operation, the system 202 is configured to output the structured query to the user device 206. In an example, by presenting the structured query to the user device 206, the system 202 allows users to review the exact command that may be utilized for execution against the database. This allows users to verify that the query aligns with their original request and expectations.

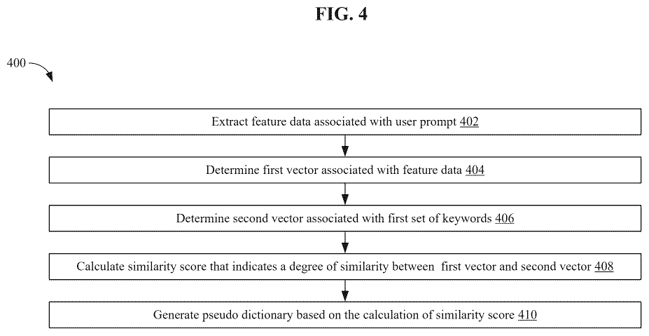

In an embodiment, the system 202 includes additional components for enabling the generation of extended prompt. These components are further shown in conjunction with FIG. 4.

FIG. 4 is a diagram that illustrates a flowchart 400 for generation of a pseudo dictionary based on a similarity score, in accordance with an embodiment of the disclosure. FIG. 4 is explained in conjunction with elements of FIG. 1, FIG. 2, and FIG. 3. With reference to FIG. 4, there is shown a flowchart 400. The operations of the exemplary method may be executed by any computing system, for example, by the computer 102 of FIG. 1 or the system 202 of FIG. 2. The operations of the flowchart 400 may start at 402.

At 402, feature data associated with the user prompt 206A is extracted. In an embodiment, the system 202 is configured to extract the feature data associated with the user prompt 206A. The feature data includes at least domain-specific data or business terms. In an example, domain-specific data refers to information that is unique to a particular industry or field, such as terminology, metrics, or standards that are commonly used within that domain. For instance, in a healthcare context, the domain-specific data may include terms like “patient admission,” “diagnosis codes,” or “treatment protocols”. Similarly, in a financial context, the domain-specific data includes terms such as, but not limited to, “ROI,” “net profit,” or “asset allocation”.

By identifying and extracting the feature data associated with the user prompt 206A, the system 202 may better align responses with the user's expectations and the specific context of their inquiry. This extraction process enhances the ability of the system 202 to generate accurate and relevant outputs, ensuring that the subsequent operations such as query generation and data retrieval are informed by a clear understanding of the demands of the user.

At 404, a first vector associated with the user prompt 206A is determined. In an embodiment, the system 202 is configured to determine the first vector associated with feature data. In an example, the first vector is derived from the feature data extracted from the user prompt 206A, which includes domain-specific information and relevant business terms.

In this context, a vector is a mathematical representation of the feature data, typically in a multi-dimensional space. Each dimension of the vector corresponds to a specific feature or attribute of the feature data. For instance, if the feature data includes terms related to sales performance, the first vector might encapsulate dimensions such as “total sales,” “customer engagement,” and “market trends.” By converting these qualitative features into a numerical format, the system 202 provide various computational processes, including similarity calculations, clustering, and classification.

The determination of the first vector often involves techniques such as word embeddings, where words or phrases are mapped to vectors in a continuous vector space based on their semantic meanings. This allows the system 202 to capture the relationships and contextual nuances of the feature data effectively.

At 406, a second vector is associated with the first set of keywords 202A. In an embodiment, the system 202 is configured to determine a second vector associated with the first set of keywords 202A. In an example, the second vector is generated based on the first set of keywords 202A that are relevant to the context of the user prompt 206A.

By way of example, and not by limitation, the first set of keywords 202A includes terms that encapsulate the core concepts or themes relevant to the user prompt 206A. For example, if the user prompt 206A pertains to marketing analysis, the first set of keywords 202A include terms like “sale performance,” “customer demographics,” and “conversion rates.” The second vector is constructed by translating the first set of keywords 202A into a numerical format, similar to the first vector, allowing the system 202 to represent the semantic meaning of the first set of keywords 202A in a multi-dimensional space. To create the second vector, the system 202 may employ techniques such as term frequency-inverse document frequency (TF-IDF) or word embeddings, which capture the relationships between the first set of keywords 202A and their contextual significance. This vectorization process enables the system 202 to quantify the importance of each keyword of the set of keywords 202A relative to the overall context of the user prompt 206A.

Once the second vector is determined, it may be utilized in various analytical processes, such as similarity matching, clustering, or further refining the query generation process. By integrating this second vector with the first vector, the system 202 enhances its understanding of the user's intent, ultimately leading to more accurate and contextually relevant responses.

At 408, a similarity score that indicates a degree of similarity between the first vector and the second vector is calculated. In an embodiment, the system 202 is configured to calculate a similarity score that indicates a degree of similarity between the first vector and the second vector. In an example, the similarity score serves as a quantitative measure of the alignment between the user prompt 206A, represented by the first vector, and the context of the first set of keywords 202A in the second vector.

By way of example, and not by limitation, to calculate the similarity score, the system 202 may employ mathematical techniques such as, but not limited to, cosine similarity, and Euclidean distance. In an embodiment, the cosine similarity, for instance, evaluates the cosine of the angle between the two vectors in a multi-dimensional space, providing a score that ranges from −1 to 1. A score closer to 1 indicates a high degree of similarity, while a score closer to 0 suggests minimal similarity. This approach allows the system 202 to effectively gauge how well the feature data and the first set of keywords 202A correspond to the user prompt 206A.

The calculated similarity score is instrumental in various subsequent processes, such as ranking potential responses, filtering relevant data, or refining the extended prompt 202C for more accurate results. By leveraging the similarity score, the system 202 may prioritize outputs that are most aligned with the user prompt 206A, enhancing the overall user experience.

This ensures that the system 202 delivers contextually appropriate and relevant information, thereby improving the effectiveness of the interaction and fostering a more intuitive and responsive user interface. The similarity score acts as a bridge between the user's input and the ability of the system 202 to generate meaningful responses.

At 410, the pseudo dictionary based on the calculation of the similarity score is generated. In an embodiment, the system 202 is configured to generate the pseudo dictionary based on the calculation of the similarity score. The pseudo dictionary includes the mapping of the first set of keywords 202A and the user prompt 206A. In an example, the pseudo dictionary acts as a structured repository that maps the first set of keywords 202A to the user prompt 206A, thereby facilitating a more organized and efficient understanding of user intent and context.

By way of example, and not by limitation, the generation of the pseudo dictionary includes compiling the first set of keywords 202A identified as significant in relation to the user prompt 206A, along with their corresponding similarity scores. Each entry in the pseudo dictionary typically consists of a keyword from the first set and its associated similarity score, which indicates how closely the first set of keywords 202A aligns with the user prompt 206A. This mapping allows the system 202 to prioritize keywords from the first set of keywords 202A that are most relevant, thereby improving the accuracy and relevance of subsequent responses.

In an embodiment, the pseudo dictionary may also include additional metadata, such as the context in which the keyword from the set of keywords were used, their frequency of occurrence in previous interactions, or even user-specific preferences. This enriched information may further enhance understanding of the system 202 of user behavior, enabling the system 202 to tailor responses more effectively. The pseudo dictionary plays a vital role in various applications, including query expansion, information retrieval, and response generation. By leveraging this structured mapping, the system 202 efficiently retrieves and presents information that is not only relevant but also aligned with the user's specific demands and context. In an embodiment, the pseudo dictionary allows for a nuanced understanding of user inquiries, ensuring that the system 202 may adapt and provide meaningful insights, thereby enhancing the overall user experience and fostering a more intuitive interaction.

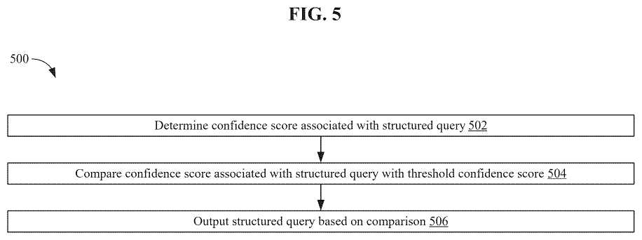

In an embodiment, the system 202 includes additional components for enabling generation of the structured query. These component are further shown in conjunction with FIG. 5.

FIG. 5 is a diagram that illustrates a method flowchart for outputting the structured query, in accordance with an embodiment of the disclosure. FIG. 5 is explained in conjunction with elements of FIG. 1, FIG. 2, FIG. 3, and FIG. 4. With reference to FIG. 5, there is shown a flowchart 500. The operations of the exemplary method may be executed by any computing system, for example, by the computer 102 of FIG. 1 or the system 202 of FIG. 2. The operations of the flowchart 500 may start at 502.

At 502, a confidence score associated with the structured query is determined. In an embodiment, the system 202 is configured to determine the confidence score associated with the structured query. The confidence score is indicative of a contextual accuracy of the structured query in accordance with at least one of the set of domain-specific terms, the set of business logic rules, and the context-specific information. In an example, the confidence score serves as an indicator of how well the structured query aligns with domain-specific terms, business logic rules, and context-specific information, thereby providing insights into the reliability and relevance of the structured query.

By way of example, and not by limitation, the determination of the confidence score involves analyzing the structured query against a predefined set of criteria. First, the system 202 evaluates the alignment of the structured query with domain-specific terms, which are specialized vocabulary or jargon pertinent to a particular field or industry. This ensures that the structured query uses terminology that is recognized and understood within the relevant context, enhancing its accuracy. Further, the system 202 assesses the structured query against a set of business logic rules. The business rules define the operational parameters and constraints within which the business operates. By ensuring that the structured query adheres to the set of business logic rules, the system 202 may ascertain that the structured query is contextually appropriate and also actionable within the business framework. Additionally, the system 202 considers context-specific information, which may include user preferences, historical data, or situational factors that could influence the interpretation of the structured query. By integrating this contextual data, the confidence score becomes a more comprehensive measure of validity of the structured query.

For example, the determined confidence score is utilized for guiding subsequent actions, such as refining the structured query, prioritizing responses, or triggering specific workflows. A higher confidence score indicates a greater likelihood that the structured query will yield relevant and accurate results, while a lower score may prompt the system 202 to suggest modifications or seek further clarification from the user. Ultimately, this process enhances the ability of the system 202 to deliver precise and contextually relevant information, thereby improving the overall user experience and operational efficiency.

At 504, the confidence score associated with the structured query is compared with a threshold confidence score. In an embodiment, the system 202 is configured to compare the confidence score associated with the structured query with the threshold confidence score. In an example, the comparison is utilized for evaluating the reliability and appropriateness of the structured query before proceeding with further actions.

By way of example, and not by limitation, the threshold confidence score serves as a benchmark that determines the minimum acceptable level of confidence score for the structured query to be considered valid. By establishing the threshold confidence score, the system 202 effectively filters out the structured queries that may lack sufficient contextual accuracy or relevance. If the confidence score of the structured query meets or exceeds the threshold confidence score, it indicates that the structured query is likely to yield accurate and meaningful results, allowing the system 202 to proceed with processing the structured query or generating a response. Conversely, if the confidence score falls below the threshold confidence score, it signals potential issues with the accuracy of the structured query or relevance. In such cases, the system 202 may initiate corrective actions, such as prompting the user for clarification, suggesting alternative queries, or refining the existing query to enhance its contextual alignment. This proactive approach helps ensure that users receive high-quality, relevant information while minimizing the risk of misinterpretation or irrelevant results.

At 506, the structured query based on the comparison is outputted. In an embodiment, the system 202 is configured to output the structured query based on the comparison. In an example, the structured query is outputted to the user device 206 based on the comparison. In an embodiment, if the confidence score is equal to or greater than the threshold confidence score, the system 202 outputs the structured query to the user device. In an embodiment, if the confidence score meets or exceeds the threshold confidence score, then the system 202 is configured to store the structured query in the database 204 for the training of the language model 202B or the generator model.

By way of example, and not by limitation, the structured query may be utilized for executing the structured query against the organizational database, retrieving relevant information, or triggering specific workflows that align with the user prompt 206A. The outputted structured query is thus deemed reliable and contextually appropriate, ensuring that the subsequent actions taken by the system 202 are based on accurate and relevant data. In contrast, if the confidence score falls below the threshold confidence score, the system 202 may take alternative actions before outputting the structured query. This may include generating a modified version of the structured query that better aligns with the established criteria, prompting the user for additional input or clarification, or even suggesting alternative queries that might yield better results. The outputting of the structured query is designed to be seamless and user-friendly, ensuring that users receive timely and relevant responses. Additionally, the system 202 may log the confidence scores and the outcomes of the comparisons for future reference, allowing for continuous improvement in query processing and user interaction.

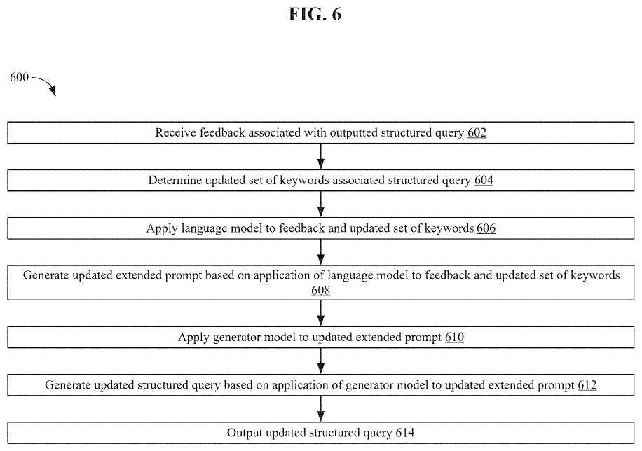

In an embodiment, the system 202 includes additional components for enabling the generation of modified extended prompt. These components are further shown in conjunction with FIG. 6.

FIG. 6 is a diagram that illustrates a method flowchart for generation of a modified extended prompt based on a feedback, in accordance with an embodiment of the disclosure. FIG. 6 is explained in conjunction with elements of FIG. 1, FIG. 2, FIG. 3, FIG. 4, and FIG. 5. With reference to FIG. 6, there is shown a flowchart 600. The operations of the exemplary method may be executed by any computing system, for example, by the computer 102 of FIG. 1 or the system 202 of FIG. 2. The operations of the flowchart 600 may start at 602.

At 602, the feedback associated with the outputted structured query is received. In an embodiment, the system 202 is configured to receive feedback associated with the outputted structured query. The feedback is received from the user device. In an example, the feedback allows for continuous improvement and refinement of the structure query processing capabilities.

By way of example, and not by limitation, when the user interacts with the system 202 and provides the user prompt, the system 202 outputs the structured query based on the user prompt 206A. After reviewing the output, the user may provide feedback regarding the relevance, accuracy, and overall satisfaction with the outputted structured query. This feedback may take various forms, such as, but not limited to, ratings, comments, or selections indicating whether the information met their expectations. The system 202 is configured to capture the feedback in real-time, ensuring that the system 202 may promptly be associated with the specific structured query. This association is utilized for analyzing the effectiveness of the structured query and understanding user preferences and demands. By collecting feedback directly from the user device 206, the system 202 gains insights into how well the structured query aligns with user intent and contextual requirements. Once the feedback is received, it may be processed and analyzed to identify patterns or trends. For instance, if multiple users consistently provide negative feedback on similar user prompt, the system 202 recognizes certain terms or logic for adjustment. Moreover, the feedback may inform future updates to the domain-specific terms, business logic rules, and contextual information used in the confidence scoring process. In an embodiment, the feedback is received via a user interface associated with the user device 206.

In an embodiment, the feedback is received via a user interface associated with the system 202.

At 604, an updated set of keywords associated with the structured query is determined. In an embodiment, the system 202 is configured to determine the updated set of keywords based on the feedback. In an example, when the feedback is received, the feedback often includes valuable insights regarding the effectiveness of the first set of keywords 202A used in the original structured query. The user may indicate that one or more keywords from the first set of keywords 202A were too broad, too specific, or not aligned with their intent. By analyzing this feedback, the system 202 identified which one or more keywords from the first set of keywords 202A contributed positively to the structured query results and which of the one or more keywords from the first set of keywords 202A may have led to confusion or irrelevant outputs.

By way of example, and not by limitation, the determination of the updated set of keywords includes analyzing the feedback to extract common themes or patterns. For instance, if multiple users suggest alternative terms or express dissatisfaction with a specific keyword from the first set of keywords 202A, the system 202 prioritizes these insights. In an embodiment, the system 202 may utilize the NLP model to understand the context and semantics of the feedback, allowing the system 202 to determine more relevant keywords. Further, the system 202 may cross-reference the updated set of keywords with existing databases, ontologies, or thesauri to ensure that they are contextually appropriate and widely recognized. Once the updated set of keywords is determined, the system 202 integrates them into the structured query. This integration enhances the immediate structure query processing and also contributes to learning algorithms the system 202, allowing the system 202 to adapt and improve over time. By continuously updating the keywords based on user feedback, the system 202 fosters a more intuitive and responsive user experience, ultimately leading to higher satisfaction and engagement.

At 606, the language model 202B is applied to the feedback and updated set of keywords. In an embodiment, the system 202 is configured to apply the language model 202B to the feedback and updated set of keywords. In an example, the application of the language model 202B enhances the ability of the system 202 to understand and generate contextually relevant queries and responses.

By way of example, and not by limitation, the language model 202B is configured to analyze natural language queries, making the system 202 adept at interpreting the nuances of user feedback. By processing the feedback, the language model 202B identifies specific sentiments, preferences, and suggestions that users have regarding the structured queries. For instance, if users express confusion over certain terms or indicate a preference for a more specific language, the language model 202B captures these insights and adjusts its understanding accordingly. Simultaneously, the updated set of keywords is fed into the language model 202B to ensure that the system 202 generates the structured queries that are relevant and linguistically coherent. The language model 202B leverages its training on vast datasets to understand the relationships between words, phrases, and concepts, allowing the system 202 to create more effective and contextually appropriate queries. Furthermore, the application of the language model 202B provides the generation of alternative structure query or suggestions based on the updated set of keywords.

At 608, an updated extended prompt is generated based on the application of the language model 202B to the feedback and the updated set of keywords. In an embodiment, the system 202 is configured to generate the updated extended prompt based on the application of the language model 202B to the feedback and the updated set of keywords. In an example, the generation of the updated extended prompt refines the interaction between the user and the system 202. The updated extended prompt serves as a comprehensive input that encapsulates the nuances of the feedback and the updated set of keywords. By synthesizing this information, the language model 202B generates the updated extended prompt that effectively guides the system 202 in generating responses that are tailored to the user demands. For instance, if the feedback indicated a preference for more detailed explanations or specific examples, the updated extended prompt may incorporate these elements, enhancing the overall quality of the output.

By way of example, and not by limitation, the generation of the updated extended prompt includes the language model 202B to analyze the feedback to identify specific user sentiments and preferences. This analysis helps classify what aspects of the previous structured queries are successful and which areas should be improved. Next, the language model 202B integrates the updated set of keywords, ensuring that they are seamlessly woven into the prompt to maintain coherence and relevance. Additionally, the language model 202B utilizes its understanding of language patterns and contextual relationships to enhance the updated extended prompt. This may involve rephrasing, adding qualifiers, or suggesting alternative structures that better capture the feedback associated with the user.

At 610, the generated model is applied to the updated extended prompt. In an embodiment, the system 202 is configured to apply the generator model to the updated extended prompt. In an example, the generator model is configured to interpret the updated extended prompt, leveraging its training on diverse datasets to produce coherent and contextually relevant responses. By applying the generator model to the updated extended prompt, the system 202 generates text that aligns with the user's intent, incorporating the insights derived from user feedback and the updated set of keywords. For example, the generator model analyzes the structure and content of the updated extended prompt, ensuring that the output is not only informative but also engaging. The generator model may produce various forms of content, such as answers to questions, explanations, or suggestions, depending on the context provided by the updated extended prompt.

At 612, an updated structured query is generated based on the application of the generator model to the updated extended prompt. In an embodiment, the system 202 is configured to generate the updated structured query based on the application of the generator model to the updated extended prompt. In an example, the generator model translates the refined information from the updated extended prompt into a format that may be effectively processed by databases or search engines, thereby facilitating accurate and relevant responses to user inquiries. The updated structured query is generated to encapsulate the insights derived from the user feedback, the updated keywords, and the context provided by the extended prompt. By synthesizing these elements, the system 202 ensures that the updated structure query is not only precise but also aligned with the user's intent. This alignment is vital for enhancing the relevance of the results returned by the underlying data sources.

By way of example, and not by limitation, the generator model interprets the updated extended prompt and forms the updated structured query that adheres to the syntax and semantics appropriate to the target system. This may involve organizing the updated structured query into specific fields, applying filters, or defining parameters that reflect the demands of the user. For example, if the updated extended prompt indicates a request for specific data types or categories, the updated structured query will incorporate these specifications to optimize the search. Moreover, the generation of the updated structured query is an iterative process. The system 202 continuously refines the query based on real-time feedback and performance metrics, ensuring that it adapts to changing user preferences and information requirements.

At 614, the updated structure query is outputted. In an embodiment, the system 202 is configured to output the updated structured query. In an embodiment, the system 202 is configured to render the updated structured query directly to the user device 206. This allows users to see the updated structure query that has been generated based on the user prompt 206A and feedback. Additionally, the system 202 may store the updated structured query in the database 204 for future reference. This allows the system 202 to maintain a historical record of queries, which may be analyzed to identify trends in user behavior and preferences over time. Further, a repository of structured queries may facilitate the optimization of future queries, as the system 202 may learn from past interactions to improve accuracy and relevance.

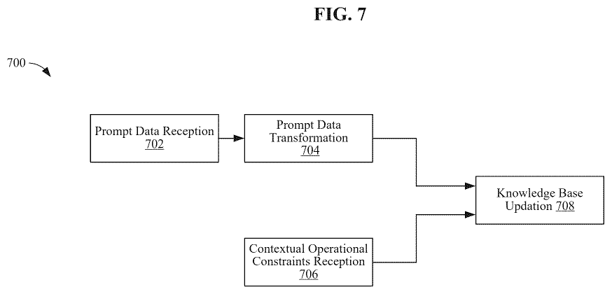

In an embodiment, the system 202 includes additional components for enabling the updation of the knowledge base 204A. These components are further shown in conjunction with FIG. 7.

FIG. 7 is a diagram that illustrates a block diagram 700 of one or more operations performed by the system 202 for updation of the knowledge base 204A based on prompt data and contextual operational constraints, in accordance with an embodiment of the disclosure. FIG. 3 is explained in conjunction with elements from FIG. 1, FIG. 2, FIG. 3, FIG. 4, FIG. 5, and FIG. 6. With reference to FIG. 7, the operations may start at 702.

At 702, a prompt data reception operation is executed. In the prompt data reception operation, the system 202 is configured to receive the prompt data associated with one or more prompts. In an example, the prompt data may include prompts received from the one or more user devices. The prompt data may include the schema details like column name, and enumerated number associated with a source table associated with the organizational database. In an example, the system 202 receives the column name associated with the source table.

By way of example, and not by limitation, the prompt data includes a wide range of information, including user-generated prompts, schema details, and other relevant metadata. In this context, the prompt data may originate from one or more user devices. Users interact with the system 202 by submitting prompts that reflect their inquiries or requests for information. These prompts may vary in complexity, from simple questions to more intricate requests that require detailed data retrieval. One critical aspect of the prompt data is the inclusion of schema details. The schema details provide the structural framework for the data stored in the organizational database. This includes information such as column names, data types, and relationships between tables. For instance, when the system 202 receives a prompt, it may also receive specific schema details that indicate which source table the prompt is referencing. This information is vital for ensuring that the system 202 accurately interprets the user's request and retrieves the appropriate data.

In an example, the system 202 receives the prompt data that includes a request for sales data from a specific time period. Along with this prompt, the system 202 could also receive schema details indicating the relevant column names, such as “Sales Amount,” “TransactionDate,” and “CustomerID,” associated with the source table “Sales Records.” This structured information allows the system 202 to construct a precise query that targets the correct data fields within the database.

Moreover, the reception of prompt data is not a one-time event; it is an ongoing process that allows the system 202 to adapt to new user inputs and changing data requirements. By continuously receiving and processing prompt data, the system 202 may refine its understanding of user demands and improve the accuracy of its responses.

At 704, a prompt data transformation operation is executed. In the prompt data transformation operation, the system 202 is configured to transform the prompt data into a first dictionary associated with the knowledge base 204A. The first dictionary includes a mapping of the prompt data to the first set of keywords. In an example, the system 202 is configured to transform the incoming prompt data into the first dictionary, which serves as a mapping tool that aligns the prompt data with a predefined set of keywords. The first dictionary is configured to facilitate the organization and retrieval of information by establishing clear associations between the user prompt 206A and the relevant keywords within the knowledge base 204A. This mapping process ensures that the system 202 accurately interprets the user prompt 206A and responds appropriately. For instance, if the user submits a prompt related to risk assessment, the system 202 will identify key terms within the prompt and map them to corresponding keywords in the first set of keywords 202A. For instance, the user may correspond to an administrator who provides the one or more business rules associated with the first set of keywords.

In an example, the mapping may involve associating specific rules with the first set of keywords 202A. For instance, if the prompt data includes terms like “risky assets” or “warranty status,” the system 202 might map these terms to establish the one or more business rules that define how risk is calculated based on warranty validity or incident frequency.

At 706, contextual operational constraints reception operation is executed. In the contextual operational constraints reception operation, the system 202 is configured to receive one or more contextual operational constraints comprising the one or more business rules and one or more input enhancement rules. In an example, the system 202 is configured to receive and integrate one or more contextual operational constraints that guide its decision-making and processing capabilities. These constraints typically encompass two primary categories: business rules and input enhancement rules.

In an embodiment, the business rules are predefined guidelines that dictate how the system 202 should operate within specific contexts. They may include regulations, compliance requirements, or organizational policies that must be adhered to when processing user requests. For example, a business rule might specify that only assets with a valid warranty may be considered in risk assessments, thereby ensuring that the outputs of the system 202 align with the organizational risk management strategies.

In an embodiment, the system 202 receives input enhancement rules. The input enhancement rules are configured to improve the quality and relevance of the input data before it is processed. The input enhancement rules may involve data validation checks, normalization processes, or enrichment techniques that ensure the prompt data is accurate and comprehensive. For instance, an input enhancement rule might require that all asset names be standardized to a specific format, thereby reducing ambiguity, and improving the reliability of the subsequent analysis. By receiving and integrating the contextual operational constraints, the system 202 enhances its ability to process the user prompt 206A effectively and generate accurate outputs. This operation ensures that the system 202 operates within the defined parameters of the business environment, ultimately leading to more reliable and contextually appropriate responses. The incorporation of both business rules and input enhancement rules is vital for maintaining the integrity and effectiveness of the system 202 operations, ensuring that user interactions yield meaningful and actionable insights.

At 708, a knowledge base updation operation is executed. In the knowledge base updation operation, the system 202 is configured to update the knowledge base 204A based on the second dictionary. In an embodiment, the system 202 is configured to update the knowledge base 204A based on the received one or more contextual operational constraints. In an example, based on the second dictionary and contextual operational constraints the knowledge base 204A is updated.

By way of example, and not by limitation, the second dictionary serves as a refined mapping tool that captures the relationships between the user's input, the contextual operational constraints, and the existing knowledge within the knowledge base 204A. By utilizing this dictionary, system 202 identifies gaps or areas where the knowledge base 204A requires enhancement or modification. For instance, if new business rules are introduced or existing rules are modified, the system 202 updates the knowledge base 204A to reflect these changes, ensuring that it aligns with the latest operational requirements. In addition to updating the knowledge base 204A based on the second dictionary, the system 202 may incorporate the received contextual operational constraints into this process. This means that any new business rules or input enhancement rules that have been established will be integrated into the knowledge base 204A, allowing the system 202 to adapt to evolving business environments and user demands. For example, if a new regulation mandates stricter criteria for asset evaluation, the system 202 will update the knowledge base 204A to include these criteria, thereby enhancing its decision-making capabilities.

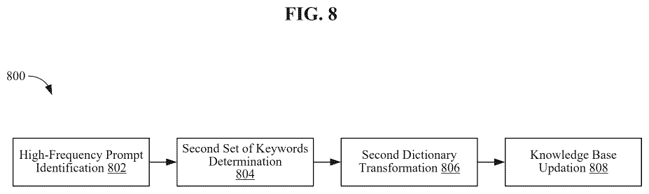

FIG. 8 is a diagram that illustrates a block diagram 800 of one or more operations performed by the system 202 for the generation of the extended prompt based on the language model 202B and the business knowledge, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, the operations may start at 802.

At 802, a high-frequency prompt identification operation is executed. In the high-frequency prompt identification operation, the system 202 is configured to identify a high-frequency prompt from the one or more prompts based on the count data associated with each prompt of the one or more prompts. In an example, system 202 analyses the one or more user prompts to identify a set of prompts that occur with high frequency, thereby allowing the system 202 to prioritize and respond to the most common user inquiries with the same response.

By way of example, and not by limitation, the system 202 is configured to evaluate one or more prompts received from the one or more users through one or more user devices similar to the user device 206. The system 202 determines the count data associated with each prompt, which reflects how often each prompt from the one or more prompts has been submitted over a specific period. For instance, if the system 202 receives the one or more user prompts, then the system 202 categorizes the one or more user prompts into identical prompts. In an example, the identical prompts correspond to the prompts with the same and similar prompts that may vary slightly in wording but convey the same intent.

By way of example, and not by limitation, consider a scenario where users frequently submit prompts related to asset management. The system 202 receives the following prompts over a week:
“Show me the top 10 risky assets.”
“List the 10 most risky assets.”
“What are the top 10 assets with the highest risk?”
   In this case, the system 202 identifies that the first two prompts are identical, while the third is similar to the first two. The system 202 then counts the occurrences of each prompt. Suppose the counts are as follows:
“Show me the top 10 risky assets.”: 120 occurrences.
“List the 10 most risky assets.”: 80 occurrences.
“What are the top 10 assets with the highest risk?”: 50 occurrences.
   Next, the system 202 aggregates the counts of identical prompts. In this example, the total count for the identical prompts “Show me the top 10 risky assets” and “List the 10 most risky assets” would be 200. The system 202 then compares this count against a predefined threshold, which in this case is set at 180.

Since the total count of 200 exceeds the threshold of 180, the system 202 identifies these identical prompts as high-frequency prompts. This identification allows the system 202 to prioritize these queries, ensuring that responses are optimized for the most common user demands. By focusing on high-frequency prompts, the system 202 may enhance user satisfaction, streamline response times, and allocate resources more effectively to address the most pressing inquiries. This proactive approach not only improves the overall user experience but also enables the system 202 to adapt and evolve based on user behavior and preferences.

At 804, a second set of keywords determination operation is executed. In an embodiment, the system 202 is configured to determine the second set of keywords associated with the high-frequency prompt. In an example, the system 202 is configured to extract and determine the second set of keywords that are associated with the high-frequency prompts, thereby improving the ability of the system 202 to respond accurately and same responds to user inquiries.

By way of example, and not by limitation, the system 202 analyzes the high-frequency prompts to identify key terms that encapsulate the essence of the user's requests. For example, if the high-frequency prompt identified is “Show me the total alerts,” then the system 202 parses this prompt to extract the second keywords that represent the user's intent. For instance, the system 202 identifies the second set of keywords associated with the high-frequency prompts. The second set of keywords may include a first keyword as “Show”, a second keyword as “Total”, and a third keyword as “Alert”. The first keyword may indicate that the user is requesting information to be displayed or presented. Further, the second keyword may signify that the user is looking for a cumulative count or summary, rather than detailed or individual entries. Further, the third keyword may specify the subject matter of the inquiry, indicating that the user is interested in information related to alerts.

By determining the second set of keywords associated with the high-frequency prompt, the system 202 enhances comprehension of the user's intent, allowing to generation of more relevant and precise responses. The identification of the second set of keywords also enables the system 202 to improve search algorithms, making it easier to retrieve and present the information that users are seeking.

Moreover, this operation may facilitate the development of advanced features such as keyword-based filtering, automated response generation, and predictive text suggestions. By leveraging the identified keywords, the system 202 may streamline user interactions, ensuring that users receive timely and relevant information. Ultimately, this second set of keywords determination operations contributes to a more intuitive and efficient user experience, aligning the system's functionalities with the specific demands and preferences of the user.

At 806, a second dictionary transformation operation is executed. In an embodiment, the system 202 is configured to transform the prompt data into a second dictionary associated with the knowledge base. The second dictionary includes a mapping of the high-frequency prompt to the second set of keywords. In this embodiment, the system 202 is designed to transform the prompt data into a structured format known as the second dictionary, which is intricately linked to the knowledge base. This transformation is utilized for establishing the mapping between high-frequency prompts and the corresponding keywords that define user intent. The second dictionary includes the mapping of high-frequency prompts to the second set of keywords identified at 804. For instance, when the system 202 identifies the high-frequency prompt “Show me the total alerts,” then the system 202 creates an entry in the second dictionary that links this prompt to its associated keywords: “Show,” “Total,” and “Alerts.” The mapping allows the system 202 to quickly reference the second set of keywords related to each prompt, facilitating efficient processing and accurate response generation.

In addition to the mapping of the one or more prompts to the second set of keywords, the system 202 incorporates rules associated with the second set of keywords into the second dictionary. These rules provide specific instructions on how to interpret or process the keywords within the context of the knowledge base. For example, if the rule associated with the prompt “Show me the total alerts” is defined as “Select count(distinct(sale_document)) from order_info where miles_stone in (2,3,4,5),” this indicates that the system 202 should execute a query to count distinct sale documents from the order information where the milestone falls within the specified range.

By transforming the prompt data into the second dictionary, the system 202 creates a robust framework that enhances its ability to understand and respond to user inquiries. This structured approach not only improves the accuracy of responses but also allows for more complex query handling, enabling the system 202 to adapt to a wide range of user requests.

Furthermore, the second dictionary serves as a dynamic reference point for the system, allowing it to learn from user interactions and refine its mappings and rules over time. As new high-frequency prompts are identified, the system 202 may continuously update the second dictionary, ensuring that it remains relevant and effective in meeting user demands. Ultimately, the second dictionary transformation operation plays a vital role in optimizing the knowledge base of the system 202, ensuring that it delivers timely, relevant, and accurate information to users efficiently.

At 808, a knowledge base updation operation is executed. In an embodiment, the system 202 is configured to update the knowledge base based on the second dictionary. In an example, the system 202 updates the knowledge base 204A so that the system 202 outputs the structured query based on the updated knowledge base. In an embodiment, the system 202 is configured to update the knowledge base 204A using the information contained in the second dictionary. This update is utilizes for maintaining the accuracy and relevance of the responses produced by the system 202.

The knowledge base 204A serves as the core repository of information and rules that the system 202 utilizes to generate structured prompts. By incorporating the mappings of the high-frequency prompts to their corresponding keyword of the second set of keywords and associated rules from the second dictionary, the system 202 enhances its ability to interpret user requests accurately. For example, when the user prompts “Show me the total alerts,” the system 202 may now reference the updated knowledge base to execute the appropriate structured query.

In practice, this means that the system 202 may dynamically generate structured queries based on the latest information in the knowledge base. As the knowledge base 204A is updated with new mappings and rules, the system 202 becomes increasingly adept at handling a wider variety of user inquiries, providing timely and relevant responses.

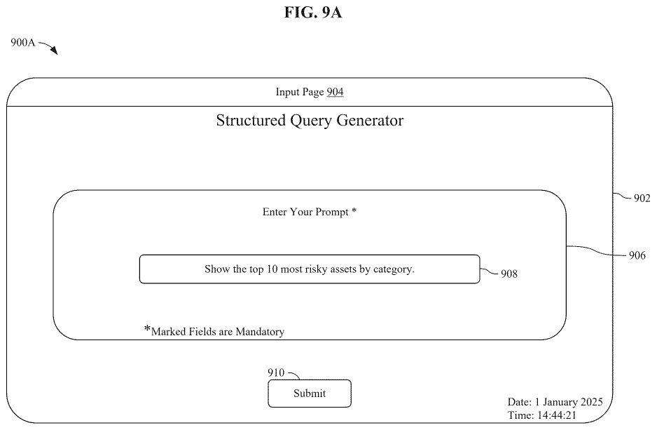

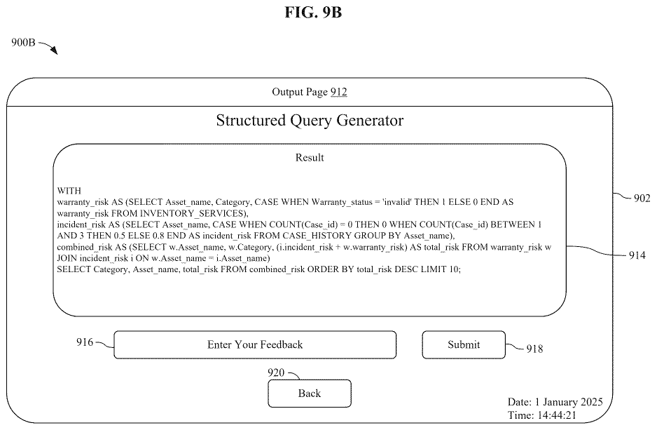

FIG. 9A is a diagram that illustrates an exemplary first user interface for performing structured query generation based on the language model 202B and the business knowledge, in accordance with an embodiment of the disclosure. FIG. 9A is explained in conjunction with elements from FIG. 1, FIG. 2, FIG. 3, FIG. 4, FIG. 5 FIG. 6, FIG. 7, and FIG. 8. With reference to FIG. 9A, there is shown an exemplary diagram 900A that includes a user device 902 and an exemplary input page 904. The exemplary input page 904 includes a first user interface (UI) element 906, a second UI element 908, and a third UI element 910. The user device 902 is an example embodiment of the user device 206 of FIG. 2.

With reference to FIG. 9A, the system 202 receives the user prompt 206A from the user device 902 (e.g., the user device 206). The user device 902 includes a display unit (a user interface) that renders the input page 904 to the user associated with the user device 902. The input page 904 corresponds to a web page or online form that is designed to receive input or commands from the user. In an example, user prompts are commonly used in various applications, including programming environments, database management systems, and software tools, allowing users to execute commands, ask questions, or provide information. In an embodiment of the disclosure, the input page 904 is used to gather relevant details from the entities for generating the structured query associated with the user prompt.

The user device 206 provides seamless interaction between the user and the application, ensuring that users easily input their queries and receive relevant information. The first UI element 906 is a textbox with a message, such as “Enter Your Prompt.”. In an example, the first UI element includes the second UI element 908, which is designated for capturing user input from the user device 902.

To further enhance the user experience, the input page 904 includes the third UI element 910, which corresponds to a submit button. This submit button plays a critical role in the interaction process. Once the user has entered their prompt into the second UI element 908, they may click on the third UI element 910 to submit their request. This action signals the system 202 to begin processing the user prompt 206A.

Upon clicking the submit button, the system 202 transitions from the input phase to the processing phase. The system 202 begins to execute the algorithms and queries to retrieve the requested information. For instance, when the user types their query into this second UI element 908, the system 202 is prepared to process the information. For example, if the user inputs the prompt, “Show the top 10 most risky assets by category”, then upon receiving the user prompt, the system 202 initiates a comprehensive analysis of the input. This analysis includes the utilization of the language model 202B which interprets the user's request, breaking it down into understandable components. The language model 202B is trained to recognize various phrases and terminologies, allowing it to discern the intent behind the user's query. In conjunction with this, the system 202 also leverages its business knowledge, which provides context and relevance to the data being requested. This dual approach ensures that the system 202 may accurately interpret the user's demands and deliver precise results.

FIG. 9B is a diagram that illustrates an exemplary second user interface for performing structured query generation based on the language model and the business knowledge, in accordance with an embodiment of the disclosure. FIG. 9B is explained in conjunction with elements from FIG. 1, FIG. 2, FIG. 3, FIG. 4, FIG. 5 FIG. 6, FIG. 7, FIG. 8, FIG. 9A. With reference to FIG. 9B, there is shown an exemplary diagram 900B that includes the user device 902 and an exemplary output page 912.

In an embodiment, the user device 902 is equipped with a display unit configured to render the output page 912 based on user interactions with the graphical user interface (GUI). Specifically, when the user selects the third UI element 910, the system 202 responds by generating and displaying an output page that corresponds to the structured query associated with the user prompt 206A entered in the second UI element 908. This interaction is designed to facilitate a seamless user experience, allowing users to easily access and understand the results of their queries.

The structured query output is presented in a fourth UI element 914. For instance, if the user inputs the prompt “show the top 10 most risky assets by category,” the system 202 leverages the knowledge base 204A to define the parameters of risk. The business knowledge extracted from the knowledge base 204A outlines various factors contributing to risk assessment, such as:

Risk is defined as follows:
Warranty status: invalid warranty is more risky. invalid>risk_score=1; valid>risk_score=0
Number of incidents: more incidents is more risky. 0 incidents>risk_score=0; 1-3 incidents>risk_score=0.5; More than 3 incidents>risk_score=0.8
Stock level: higher count is more risky.

Further, the knowledge base 204A may include a template for the structured query, for example, SELECT Asset_name, Category, CASE WHEN Warranty_status32 ‘invalid’ THEN 1 ELSE 0 END AS warranty_risk FROM INVENTORY_SERVICES;
SELECT Asset_name, CASE WHEN COUNT(Case_id)=0 THEN 0 WHEN COUNT(Case_id) BETWEEN 1 AND 3 THEN 0.5 ELSE 0.8 END AS incident_risk FROM CASE_HISTORY GROUP BY Asset_name;

Further, the system 202 utilizes the language model 202B and the generator model to generate the structured query and render it in the fourth UI element 914. the system 202 may render the structure query as:
“WITH warranty_risk AS (SELECT Asset_name, Category, CASE WHEN Warranty_status=‘invalid’ THEN 1 ELSE 0 END AS warranty_risk FROM INVENTORY_SERVICES), incident_risk AS (SELECT Asset_name, CASE WHEN COUNT(Case_id)=0 THEN 0 WHEN COUNT(Case_id) BETWEEN 1 AND 3 THEN 0.5 ELSE 0.8 END AS incident_risk FROM CASE_HISTORY GROUP BY Asset_name), combined_risk AS (SELECT w. Asset_name, w. Category, (i. incident_risk +w. warranty_risk) AS total_risk FROM warranty_risk w JOIN incident_risk i ON w. Asset_name=i. Asset_name) SELECT Category, Asset_name, total_risk FROM combined_risk ORDER BY total_risk DESC LIMIT 10;”

This structured query employs common table expressions (CTEs) to calculate warranty risk and incident risk, ultimately combining these metrics to derive a total risk score for each asset. The final output query selects the top 10 assets based on their total risk score, sorted in descending order.

In addition to the structured query, the output page 912 is designed to enhance user interaction through additional UI elements. The output page 912 may include a fifth UI element 916, a sixth UI element 918, and a seventh UI element 920. The fifth UI element 916 is designed to receive user feedback regarding the structured query. This feedback mechanism is vital for continuous improvement, as it allows users to express their satisfaction or concerns about the output they received.

Once the user provides feedback through the fifth UI element 916, the sixth UI element 918 features a button that, when clicked, transmits the feedback back to the system 202. This feedback loop is vital for refining the performance of the system 202 and ensuring that it aligns with user expectations. The system 202 analyzes this feedback to make adjustments, improving the accuracy and relevance of future outputs.

Moreover, if the user is satisfied with the output displayed in the fourth UI element 914, the seventh UI element 920 offers an option to return to the input page 904. This functionality allows users to easily initiate new user prompt 206A without navigating through multiple screens, thereby streamlining the overall user experience.

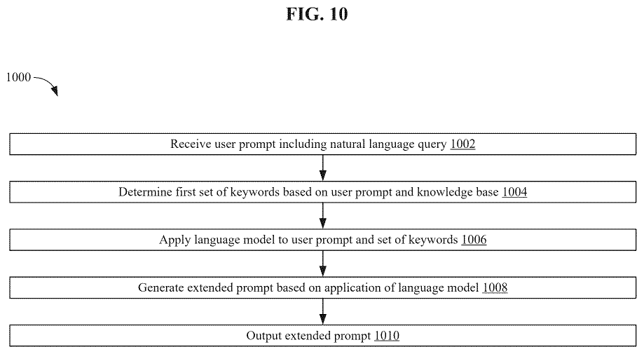

FIG. 10 illustrates a flowchart 1000 of an exemplary method for the generation of the extended prompt 202C associated with the user prompt 206A, in accordance with an embodiment of the disclosure. FIG. 10 is explained in conjunction with elements of FIG. 1, FIG. 2, FIG. 3, FIG. 4, FIG. 5, FIG. 6, FIG. 7, FIG. 8, FIG. 9A and FIG. 9B. With reference to FIG. 10, there is shown a flowchart 1000. The operations of the exemplary method may be executed by any computing system, for example, by the computer 102 of FIG. 1 or the system 202 of FIG. 2. The operations of the flowchart 1000 may start at 1002.

At 1002, the user prompt 206A including the natural language query is received. In an embodiment, the system 202 is configured to receive the user prompt 206A including the natural language query. The user prompt 206A is received from the user device 206. Details of the reception of the user prompt 206A are further described in conjunction with, for example, FIG. 3.

At 1004, the first set of keywords 202A is based on the user prompt, and the knowledge base 204A is determined. In an embodiment, the system 202 is configured to determine the first set of keywords 202A based on the user prompt 206A and the knowledge base 204A, the first set of keywords 202A includes at least one of the set of domain-specific terms, the set of business logic rules, and context-specific information associated with the user prompt. The knowledge base 204A includes at least one of historical user prompts or one or more business rules. The details are further described in conjunction with FIG. 3.

At 1006, the language model 202B is applied to the user prompt and the first set of keywords 202A. In an embodiment, the system 202 is configured to apply the language model 202B to the user prompt 206A and the first set of keywords. The details are further described in conjunction with FIG. 3.

At 1008, the extended prompt 202C based on the application of the language model 202B is generated. In an embodiment, the system 202 is configured to generate the extended prompt 202C based on the application of the language model 202B to the user prompt 206A and the first set of keywords 202A. In an embodiment, the extended prompt 202C corresponds to the pseudo-structured query. The details are further described in conjunction with FIG. 3.

At 1010, the extended prompt 202C is outputted. In an embodiment, the system 202 is configured to output the extended prompt 202C. In an embodiment, the system 202 is configured to render the extended prompt 202C to the user device 206. In an embodiment, the system 202 is configured to store the extended prompt 202C to the database 204. The details are further described in conjunction with FIG. 3.

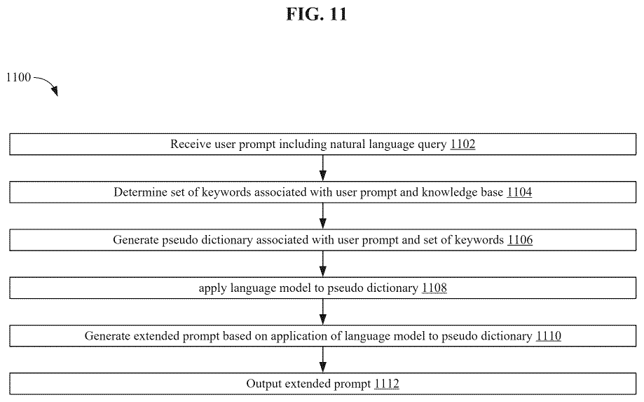

FIG. 11 illustrates a flowchart 1100 of an exemplary method for the generation of the extended prompt 202C associated with the user prompt 206A, in accordance with an embodiment of the disclosure. FIG. 11 is explained in conjunction with elements of FIG. 1, FIG. 2, FIG. 3, FIG. 4, FIG. 5, FIG. 6, FIG. 7, FIG. 8, FIG. 9A, FIG. 9B, and FIG. 10. With reference to FIG. 11, there is shown a flowchart 1100. The operations of the exemplary method may be executed by any computing system, for example, by the computer 102 of FIG. 1 or the system 202 of FIG. 2. The operations of the flowchart 1100 may start at 1102.

At 1102, the user prompt 206A is received. The user prompt 206A includes a natural language query. In an embodiment, the system 202 is configured to receive the user prompt 206A that includes the natural language query. The user prompt 206A is received from the user device 206.

At 1104, the first set of keywords 202A is determined based on the user prompt 206A and the knowledge base 204A, the first set of keywords 202A. In an embodiment, the system 202 is configured to determine the first set of keywords 202A based on the user prompt 206A and the knowledge base 204A. The first set of keywords 202A includes at least one of the set of domain-specific terms, the set of business logic rules, and context-specific information associated with the user prompt. The knowledge base 204A includes at least one of historical user prompts or one or more business rules;

At 1106, the pseudo dictionary is associated with the user prompt, and the set of keywords 202A is generated. In an embodiment, the system 202 is configured to generate the pseudo dictionary associated with the user prompt 206A and the first set of keywords 202A. The pseudo dictionary includes the mapping of the first set of keywords 202A to the user prompt 206A.

At 1108, the language model 202B is applied to the pseudo dictionary. In an embodiment, the system 202 is configured to apply the language model 202B to the pseudo dictionary. In an example, the language model 202B may correspond to the large language model.

At 1110, the extended prompt 202C is generated based on the application of the language model 202B to the pseudo dictionary. In an embodiment, the system 202 is configured to generate the extended prompt 202C based on the application of the language model 202B to the pseudo dictionary. In an embodiment, the extended prompt 202C corresponds to the pseudo-structured query. By way of example, and not by limitation, the system 202 is configured to generate the pseudo-structured query that reflects a more detailed and structured interpretation of the user prompt 206A, based on the application of the language model 202B to the pseudo dictionary.

At 1112, the extended prompt 202C is outputted. In an embodiment, the system 202 is configured to output the extended prompt 202C. For instance, the system 202 is configured to render the extended prompt 202C to the user device 206. In an embodiment, the system 202 is configured to store the extended prompt 202C to the database 204. In an embodiment, the system 202 is configured to output the extended prompt 202C to the generator model to generate the structured query associated with the user prompt.

In various embodiments of the disclosure, a computer program product for generation of the extended prompt 202C associated with the user prompt 206A is described. The computer program product includes a computer-readable storage medium having program instructions stored on the computer-readable storage media to perform operations. The operations include receiving the user prompt 206A comprising the natural language query. The user prompt 206A is received from the user device 206. The operations further include determining the first set of keywords 202A based on the user prompt 206A and the knowledge base 204A, the first set of keywords 202A includes at least one of the set of domain-specific terms, the set of business logic rules, and context-specific information associated with the user prompt 206A. The knowledge base 204A includes at least one of historical user prompts or one or more business rules. The operations further include applying the language model 202B to the user prompt 206A and the first set of keywords 202A. The operations further include generating the extended prompt 202C based on the application of the language model 202B to the user prompt 206A and the first set of keywords 202A. The operations further include outputting the generated extended prompt 202C.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enables ordinary skill in the art to understand the embodiments disclosed herein.

What is claimed is:

1. A computer-implemented method, comprising:
receiving, by a computer, a user prompt comprising a natural language query, wherein the user prompt is received from a user device;
determining, by the computer, a first set of keywords based on the user prompt and a knowledge base, wherein the first set of keywords comprises at least one of a set of domain-specific terms, a set of business logic rules, or context-specific information associated with the user prompt, and wherein the knowledge base comprises at least one of historical user prompts or one or more business rules;
applying, by the computer, a language model to the user prompt and the first set of keywords;
generating, by the computer, an extended prompt based on the application of the language model to the user prompt and the first set of keywords; and
outputting, by the computer, the generated extended prompt.

2. The computer-implemented method of claim 1, wherein the extended prompt corresponds to a pseudo-structured query.

3. The computer-implemented method of claim 1, further comprising:
applying, by the computer, a generator model to the generated extended prompt;
generating, by the computer, a structured query based on the application of the generator model to the generated extended prompt; and
outputting, by the computer, the structured query.

4. The computer-implemented method of claim 3, further comprising:
determining, by the computer, a confidence score associated with the structured query, wherein the confidence score is indicative of a contextual accuracy of the structured query based on at least one of the set of domain-specific terms, the set of business logic rules, or the context-specific information;
comparing, by the computer, the confidence score associated with the structured query with a threshold confidence score; and
outputting, by the computer, the structured query based on the comparison.

5. The computer-implemented method of claim 3, further comprising:
receiving, by the computer, feedback associated with the outputted structured query, wherein the feedback is received from the user device;
determining, by the computer, an updated set of keywords based on the feedback;
applying, by the computer, the language model to the feedback and the updated set of keywords;
generating, by the computer, an updated extended prompt based on the application of the language model to the feedback and the updated set of keywords;
applying, by the computer, the generator model to the updated extended prompt;
generating, by the computer, an updated structured query based on the application of the generator model to the updated extended prompt; and
outputting, by the computer, the updated structured query.

6. The computer-implemented method of claim 1, further comprising:
extracting, by the computer, feature data associated with the user prompt, wherein the feature data comprise at least domain-specific data or business terms;
determining, by the computer, a first vector associated with feature data;
determining, by the computer, a second vector associated with the first set of keywords;
calculating, by the computer, a similarity score that indicates a degree of similarity between the first vector and the second vector; and
generating, by the computer, a pseudo dictionary based on the determination of the similarity score, wherein the pseudo dictionary comprises a mapping of the first set of keywords to the user prompt.

7. The computer-implemented method of claim 6, further comprising:
applying, by the computer, the language model to the pseudo dictionary;
generating, by the computer, the extended prompt based on the application of the language model to the pseudo dictionary; and
outputting, by the computer, the generated extended prompt to the generator model wherein the outputting corresponds to transmission of the extended prompt to the generator model.

8. The computer-implemented method of claim 1, further comprising:
receiving, by the computer, prompt data associated with one or more prompts, wherein the one or more prompts includes the user prompt;
transforming, by the computer, the prompt data into a first dictionary associated with the knowledge base, wherein the first dictionary comprises a mapping of the prompt data to the first set of keywords; and
updating, by the computer, the knowledge base based on the first dictionary.

9. The computer-implemented method of claim 8, further comprising:
identifying, by the computer, a high-frequency prompt from the one or more prompts based on count data associated with each prompt of the one or more prompts;
determining, by the computer, a second set of keywords associated with the high-frequency prompt;
transforming, by the computer, the prompt data into a second dictionary associated with the knowledge base, wherein the second dictionary comprises a mapping of the high-frequency prompt to the second set of keywords; and
updating, by the computer, the knowledge base based on the second dictionary.

10. The computer-implemented method of claim 1, further comprising:
receiving, by the computer, one or more contextual operational constraints comprising the one or more business rules and one or more input enhancement rules; and
updating, by the computer, the knowledge base based on the received one or more contextual operational constraints.

11. A computer system, comprising:
a processor set;
one or more computer-readable storage media; and
program instructions stored on the one or more computer-readable storage media, the program instructions executable by the processor set to cause the processor set to:
receive a user prompt that comprises a natural language query, wherein the user prompt is received from a user device;
determine a first set of keywords based on the user prompt and a knowledge base, wherein the first set of keywords comprises at least one of a set of domain-specific terms, a set of business logic rules, or context-specific information associated with the user prompt, and wherein the knowledge base comprises at least one of historical user prompts, or one or more business rules;
generate a pseudo dictionary associated with the user prompt and the set of keywords, wherein the pseudo dictionary comprises the set of keywords mapped to the user prompt;
apply a language model to the pseudo dictionary;
generate an extended prompt based on an application of the language model to the pseudo dictionary; and
output the generated extended prompt.

12. The computer system of claim 11, wherein the extended prompt corresponds to a pseudo-structured query.

13. The computer system of claim 11, wherein the program instructions further cause the processor set to:
apply a generator model to the extended prompt;
generate a structured query based on the application of the generator model to the generated extended prompt; and
output the structured query.

14. The computer system of claim 13, wherein the program instructions further cause the processor set to:
determine a confidence score associated with the structured query, wherein the confidence score is indicative of a contextual accuracy of the structured query based on at least one of the set of domain-specific terms, the set of business logic rules, or the context-specific information;
compare the confidence score associated with the structured query with a threshold confidence score; and
output the structured query based on the comparison.

15. The computer system of claim 13, wherein the program instructions further cause the processor set to:
receive feedback associated with the outputted structured query, wherein the feedback is received from the user device;
determine an updated set of keywords based on the feedback;
apply the language model to the feedback and the updated set of keywords;
generate an updated extended prompt based on the application of the language model to the feedback and the updated set of keywords;
apply the generator model to the updated extended prompt;
generate an updated structured query based on the application of the generator model to the updated extended prompt; and
output the updated structured query.

16. The computer system of claim 11, wherein the program instructions further cause the processor set to:
extract feature data associated with the user prompt, wherein the feature data comprise at least domain-specific data or business terms;
determine a first vector associated with feature data;
determine a second vector associated with the set of keywords;
calculate a similarity score that indicates a degree is similarity between the first vector and the second vector; and
generate the pseudo dictionary based on the determination of the similarity score, wherein the pseudo dictionary comprises the set of keywords mapped to the user prompt.

17. The computer system of claim 11, wherein the program instructions further cause the processor set to:
receive prompt data associated with one or more prompts, wherein the one or more prompts includes the user prompt;
transform the prompt data into a first dictionary associated with the knowledge base, wherein the first dictionary comprises the prompt data mapped to the set of keywords; and
update the knowledge base based on the first dictionary.

18. The computer system of claim 17, wherein the program instructions further cause the processor set to:
identify a high-frequency prompt from the one or more prompts based on count data associated with each prompt of the one or more prompts;
determine a second set of keywords associated with the high-frequency prompt;
transform the prompt data into a second dictionary associated with the knowledge base, wherein the second dictionary comprises the high-frequency prompt mapped to the second set of keywords; and
update the knowledge base based on the second dictionary.

19. The computer system of claim 11, wherein the program instructions further cause the processor set to:
receive one or more contextual operational constraints that comprises the one or more business rules or one or more input enhancement rules; and
update the knowledge base based on the received one or more contextual operational constraints.

20. A computer program product for generation of an extended prompt based on a user prompt, the computer program product comprising:
one or more computer-readable storage media; and
program instructions stored on the one or more computer-readable storage media to perform operations comprising:
receiving the user prompt comprising a natural language query, wherein the user prompt is received from a user device;
determining a first set of keywords based on the user prompt and a knowledge base, wherein the first set of keywords comprises at least one of a set of domain-specific terms, a set of business logic rules, or context-specific information associated with the user prompt, and wherein the knowledge base comprises at least one of historical user prompts, or one or more business rules;
applying a language model to the user prompt and the first set of keywords;
generating the extended prompt based on the application of the language model; and
outputting the generated extended prompt.
